(19) United States
(12) Patent Application Publication
(10) Pub. No.: US 2010/0089327 A1
(43) Pub. Date: Apr. 15, 2010

(54) DISPENSER FOR THE PREFERABLY AUTOMATIC TRAINING OF ANIMALS, ESPECIALLY WHILE USING A TREAT DISPENSER FASTENED ON THE ANIMAL

(76) Inventor: Fritz Gross, Stuttgart (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/530,518

(22) PCT Filed: Mar. 11, 2008
(86) PCT No.: PCT/DE2008/000487

§ 371 Date: Sep. 9, 2009

(30) Foreign Application Priority Data
Mar. 11, 2007 (DE) 10 2007 012 261.8
Mar. 11, 2007 (DE) 10 2007 012 262.6
Mar. 17, 2007 (DE) 10 2007 014 233.3
Mar. 17, 2007 (DE) 10 2007 014 234.1
Apr. 9, 2007 (DE) 10 2007 017 995.4
Apr. 10, 2007 (DE) 20 2007 005 511.0
Jun. 8, 2007 (DE) 10 2007 026 616.4
Jun. 26, 2007 (DE) 10 2007 030 852.5
Jun. 26, 2007 (DE) 10 2007 030 878.9
Jun. 28, 2007 (DE) 10 2007 030 005.2
Jul. 20, 2007 (DE) 10 2007 035 040.8
Dec. 26, 2007 (DE) 10 2007 063 531.3
Dec. 27, 2007 (DE) 10 2007 063 520.8
Dec. 27, 2007 (DE) 10 2007 063 521.6
Dec. 27, 2007 (DE) 10 2007 063 522.4
Jan. 19, 2008 (DE) 10 2008 005 849.1
Feb. 7, 2008 (DE) 10 2008 009 239.8

(51) Int. Cl. A01K 15/02

(52) U.S. Cl. 119/51.01; 119/720

(57) ABSTRACT

The invention relates to various devices which allow dogs to be temporarily occupied automatically when the owner is absent.

Dogs can be trained and occupied when the owner is present, but also when the owner is absent. If the human is not present, then desired behavior can be monitored by means of mechanical and electromotive devices and rewarded by a treat dispenser which also pertains to the device. The device can in this case be switched on all day long, or it is intermittently switched off, controlled by a timing circuit. If the device is activated, then sensors and other measuring instruments ascertain whether the animal is behaving correctly, assisted by additional timing circuits, so that the factor of time can also play a decisive role. The animal is made active or to behave in the desired way by its natural drives and by learning that the behavior is always or at least occasionally rewarded with a treat. The treat dispenser is located preferably on the animal, although it can in some cases also be located in the environment. It can be an independent constructional unit or is combined in terms of design with other elements of the device. Various constructions and embodiments of the treat dispenser are required and will be described. Obviously, it would also be possible for the devices to be controlled, when a human is present, also by said human directly by means of a remote controller located in his hand, or by direct manual actuating of the individual parts of the device. However, the aim of all of the proposed devices is for them to operate completely automatically even when the owner is absent.

Various devices A-P will be described in greater detail:

A. A variant of an animal training device will be described hereinafter: This is a device which is intended to prompt the animal to retrieve articles and which automatically rewards the dog for the retrieval.

In current-day dog-keeping, many dogs are often not kept busy. This new invention seeks to allow dogs to be kept beneficially occupied even when the dog keeper is not present. Many dogs enjoy collecting, i.e. retrieving, articles. In this case, it is quite safe to require this to be done with some haste. If the entire endeavor is immediately rewarded with a treat, then the process is quickly learned. A device is therefore proposed which casts out an article and which gives the dog a treat when it brings this article back, or brings it back in a specific time. The device can be set up in the house or in the garden.

It consists partly of an ejecting means AE which allows a defined article, for example a ball B, to be cast out (FIG. 1). It also consists of a take-back box RB into which the cast-out article is to be returned. The third part of the stand-alone retrieval device consists of a treat dispenser LS.

The ejecting means AE can for example be designed like a previously known apparatus for ejecting tennis or table tennis balls. Children's toys are also known with which articles, for example balls, can be cast away, for example by an issuing bolt Bo. Ideally, the toys should be pivotably attached, so that the articles can be cast in various directions. Also, the force with which the article is cast out should be variable. A further parameter would be the time lag at which articles are at all times cast out, which can be controlled by means of a timer. An additional timer could ascertain at what times, when the dog keeper is absent, the ejecting means AE is in any way operative. The ascertainment of the ejection direction, the ejection strength and also the time lags can be set manually by the dog keeper or is controlled by a random generator. Thus, the owner can for example briefly test out, together with the dog, an ejection direction and ejection strength of the ball and then set the available time in such a way that the dog can, with some degree of speed, bring the ball back in good time. It would however also be possible for the aforementioned parameters to be determined by means of electric motors and controllers also variably in accordance with the random principle (random generator). E=electronics, controller, motors, timers, circuits.

The take-back box RB has a return chute RS for receiving the cast-out article. It also consists of a recognition system ES which recognizes without doubt whether the desired article, for example a ball, has been thrown in. In this case, use may again be made of known technologies which are used for example in coin-operated machines, can return machines, coin-operated machines. The mechanical construction of the return chute RS itself operates a certain preselection in that only specific articles can ever reach the recognition system ES. It would of course also be possible for light barriers, etc. to secure the passage of the article. It is also possible for the article (ball) to have a sensor or chip which is then unambiguously recognized by the detection system. If a wrong article is thrown in (for example a stone), then it is not accepted but rather removed (for example by means of a deflector via the lateral opening Ö) or it may pass but does not cause a treat to be given out. Alternatively, the entire sequence is stopped as a precaution.

In the case of the cast-out article being correctly returned by the animal, the treat dispenser LS immediately causes a treat L to be given out. The dog will quickly learn from this what it has to do in order to be given a treat. For the giving-out of the individual treats, a large number of constructions have already been described (such as for example in a chewing gum apparatus K, etc.). All processes are controlled by means of electronics E. Each bringing-back of an article can be rewarded with a treat. It is however also possible for this rewarding to be carried out only after a specific time interval. This time interval can be defined by the dog keeper by means of a timer or is newly determined again and again by means of a random generator.

The stand-alone retrieval device can for this purpose additionally have a sound transmitter T or a light source Li which give off signals for as long as a treat is given as a result of the returning of the article in good time. If the article is brought back only later, there is no longer a treat.

Alternatively, bringing-back in good time is rewarded with a larger amount of treats, whereas there is only a small treat for bringing-back late. That means that graded giving of treats is also possible if the system registers (for example timing circuit with precise time measurement) that a task has been completed particularly well or quickly. Then, for example, the giving-out of two or more portions is caused, or for example a large chamber of the treat dispenser is completely emptied. An additional possibility would be a built-in voice recorder V which plays back a praise prerecorded by its owner once the task has been performed.

Between the take-back box RB and the ejecting means AE there is a connection Ve, so that articles (balls) returned to the take-back box RB are available again in the ejecting means AE. This allows the entire device to operate independently over a relatively long time without an excessive number of articles (balls) having to be present. Obviously, it would also be conceivable for the ejecting means AE to operate entirely independently and to eject an article only at time lags to be determined in advance.

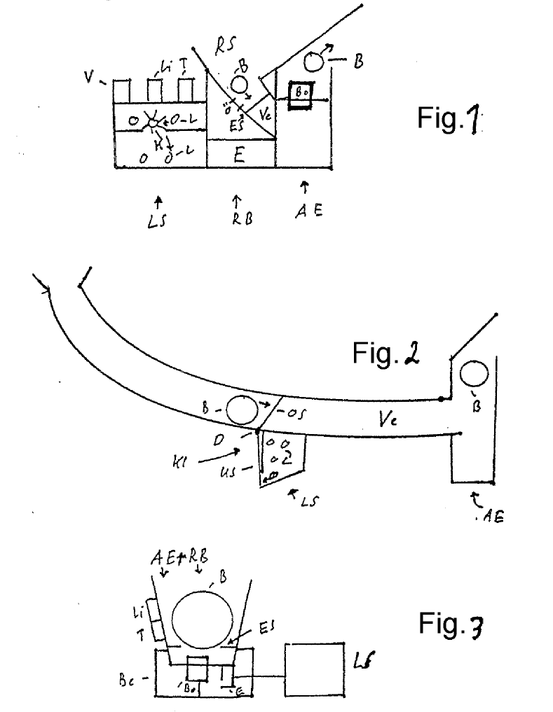

The take-back box RB and treat dispenser LS can be an independent unit which operate while possibly still being connected to the ejecting means AE via cables or a radio signal, or else react wholly independently only to the throwing-in of the article. A construction which operates completely mechanically and in the case of which a portion of treats is automatically released as a result of the falling-in of the brought-back article would also be possible in this case (FIG. 2). Thus, the upper piece OS of a flap Kl can for example be pressed down by a ball B as it rolls through. As the flap Kl has a pivot point D, the pressing-down of the upper piece OS causes the lower piece US of the flap intermittently to release an opening Of a treat dispenser, so that treats fall outward. A large number of constructions are possible. In order to save articles (balls), the brought-back (article) ball can ultimately fall back into the ejecting means AE via a connection Ve (FIG. 2). This can trigger, controlled by means of a timer, renewed ejecting after a specific time, or ejecting is immediately repeated after contacting by the ejected article.

The take-back box RB and treat dispenser LS do not necessarily have to form a unit, although nor should they be spatially too far apart from each other, as otherwise the dog will not understand that there is a relationship between returning the article and being given a treat.

It is therefore also possible for the take-back box RB to be a stand-alone unit which registers the returning of the article (in good time). The take-back box then reports this via a cable or radio to the independently operating treat dispenser, so that the treat dispenser immediately gives out a treat to the animal. The treat dispenser can also be fastened on the animal's collar, thus ensuring that the treat is at all times immediately available.

As commercial tennis or table tennis ball machines are very expensive and are too complex in their configuration with regard to the frequency and nature (spin) of the dispensing of the balls, the following construction is also recommendable. The ejecting means AE can be configured as in the case of a ball thrower for children (FIG. 3). It can however also be set up fixedly or can be fastened to the ground or to a wall by means of fastenings Be. With regard to the variation of the ejection direction, ejection strength, time lags and also active time intervals, that which was stated hereinbefore applies. A large number of constructions are conceivable to eject the article (ball). Thus, for example, a speed-imparting bolt Bo can cast out the ball (by means of an electric motor, spring, etc.). However, this ejecting means AE has the advantage that it can at the same time also operate as the take-back box RB. That is to say, when the dog places the ball back into the opening, it is recognized by a detection system RS which is also located there, causing a treat to be released by the treat dispenser LS, again via mechanical constructions, or more specifically electric circuits and connections E.

Controlled by a preset timer, timing circuit or by a random generator, recasting-out of the ball is caused after a specific time after the returning. As mentioned hereinbefore, it is in this case also possible for the time which is available for the bringing-back to be indicated by a sound transmitter T or light signal transmitter Li.

If the dog places the article back into the take-back box, or places it back in good time, and if the placed-back article is correctly recognized by the recognition system ES (sensors, mechanical arrangements of all types), then the release of a treat is triggered. This can be attained both by purely mechanical constructions and by electric switches, cables and radio connections.

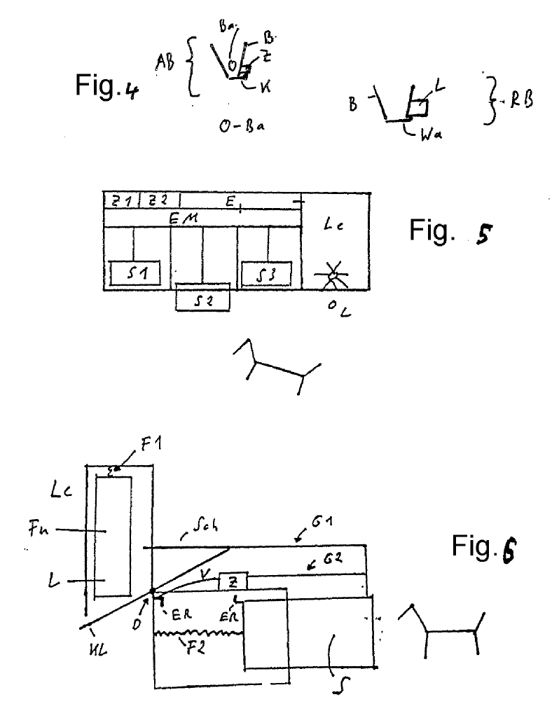

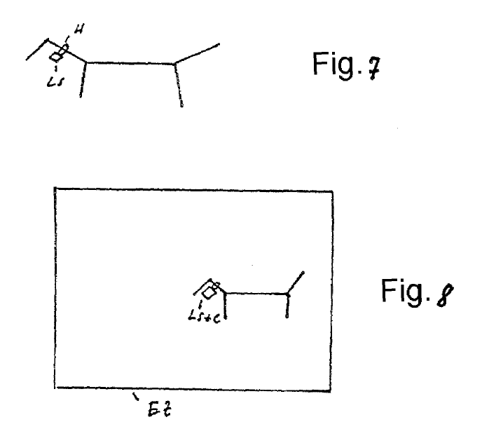

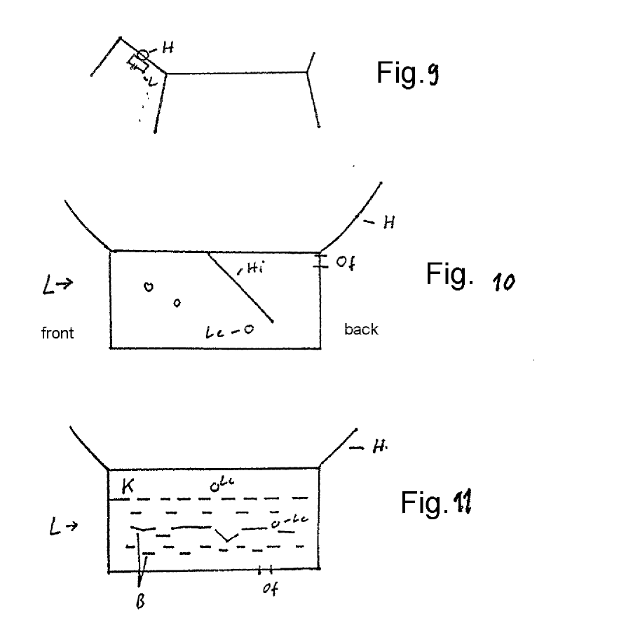

The ejecting of an article requires a certain force and accordingly also a relatively complex construction. It would therefore also be possible for the ejecting means to be located at an elevated site (for example on a tree or an upper window of a house) and for the articles to be introduced there by the human. After the periodic ejecting, or in this case releasing and allowing to fall, of an article, the article will fall down to the ground. It is easy to teach the dog to bring the article then to a return vessel located on the ground, whereupon the dog can be given a treat. The ejecting means would therefore in this case tend to be a dispensing means. It would also be possible for the article to be small and light but bulky, so that there is no risk of the dog swallowing it, and for the article to be cast away, for example using a small rubber casting means, or by an air blast generator (blower) (FIG. 4).

It would also be possible for not only one article to be given out, but rather for a large number or all articles to be given out at a given moment. Thus, a delivery box AB, erected for example in the garden or in a room, could contain for example 100 small balls which are released, controlled by a timer Z, by opening the container. In this case, for example a slide or a flap K can open, so that the balls Ba simply fall to the ground. The animal is taught that it must bring back all these articles to a take-back box RB standing on the ground. This is for example measured by a simple set of scales Wa which is integrated in the take-back box. At the moment when the measuring means reports the bringing-back of all balls, the release of a treat is brought about in an electromechanically controlled manner by the treat dispenser L, or the dog is afforded access to a place or a space (for example by opening a door) in which a large food portion is located. In order to save transferring of the balls from the take-back box to the delivery box, the receptacles B thereof for the balls could also be designed in the same way, so that the receptacles B for the balls would have merely to be exchanged for the next pass.

For the sake of clarity, it should again be emphasized that the retrieval device is not a device retrieving an article, but rather a retrieval training device which gets an animal to retrieve an article.

Summarizing statements and possible configurations of this variant of an animal training device (retrieval device):

It is characterized by at least one ejecting device for ejecting at least one article, at least one take-back device for taking back the at least one article and at least one reward dispenser for delivering a reward, in particular a treat, on taking-back of the at least one article.

In particular, provision is made for the ejecting device to have elements for casting out the at least one article, in particular at least one ball.

In particular, provision is also made for an operating sequence of the retrieval device, in particular of the ejecting device, to be time-adjustable and/or to be controllable by means of a random generator.

In particular, provision is also made for the take-back device to have mechanical and/or electronic detection elements, for example scales or other previously known mechanisms (for example a cash machine), for recognizing/detecting the at least one article.

In particular, provision is also made for it to be characterized by mechanical and/electronic means for activating the reward dispenser as a function of an article detected by the detection elements.

In particular, provision is also made for it to be embodied in such a way that a reward is given out by means of the reward dispenser on detection of the at least one article in the take-back device by means of the detection elements.

According to a development of the invention, provision is made for the ejecting device, the take-back device and the reward dispenser to be embodied as a unit or so as to be at least partly spatially separated from one another.

According to a development of the invention, provision is made for the ejecting device, the take-back device and the reward dispenser to be embodied so as to operate in adaptation to one another or to operate at least partly independently of one another.

According to a development of the invention, provision is made for the take-back device and the reward dispenser to be embodied as a mechanical unit.

According to a development of the invention, provision is made for the ejecting device to form the take-back device.

According to a development of the invention, provision is made for it to be characterized by at least one motivation element, in particular an acoustic and/or visual motivation element, for motivating the animal and/or for indicating that the animal is given a reward on bringing back the article in good time.

According to a development of the invention, provision is made for the acoustic motivation element to be a sound transmitter and/or a voice recorder.

According to a development of the invention, provision is made for it to be characterized by transport means for automatically transporting the at least one article from the take-back device to the ejecting device.

According to a development of the invention, provision is made for the reward dispenser to be embodied for giving out reward food (treats) and/or at least one other attractive article, in particular a toy.

According to a development of the invention, provision is made for the ejecting device, the take-back device and/or the reward dispenser to be connected to one another by means of a cable connection and/or radio connection.

According to a development of the invention, provision is made for it to be characterized by at least one timer or timing circuit, for defining a period of time in which the at least one article must reach the take-back device for a reward to be given out.

According to a development of the invention, provision is made for an ejection direction and/or an ejection scope of the ejecting device to be adjustable automatically and/or manually.

According to a development of the invention, provision is made for it to be characterized by dispensing means for giving out an article which has reached the take-back device and does not correspond to the at least one ejected article.

According to a development of the invention, provision is made for the issuing means to have an opening and a closure, so that after opening of the closure all articles, induced merely by gravity, leave the issuing means, and said issuing means is thus also able simultaneously to deliver a large number of articles.

The animal training device is controlled in such a way that a treat dispenser renders a food ration accessible when an article or articles, cast out or given out beforehand by an ejecting device, is or are brought (in good time) to a take-back device.

Further summarizing statements and possible configurations of this variant of an animal training device (retrieval device):
That the ejecting device has elements for casting out articles (preferably balls), and that its operating sequence is adjustable, or is controlled in a variable manner also with the aid of random generators.
That the returning device has elements for recognizing the brought-back article.
That the successful bringing-back of the article is transmitted mechanically or electronically to the treat dispenser, whereupon said treat dispenser delivers a reward.
That the ejecting device, take-back device and also treat dispenser are a unit, or operate spatially separately from one another.
That the ejecting device, take-back device and also reward dispenser operate at all times in adaptation to one another, or else operate at least partly also independently of one another.
That the take-back device and treat dispenser can be a purely mechanical unit.
That the ejecting means and take-back device can be formed by the same element.
That the device can have elements (sound transmitter, visual sign, voice recorder, etc.) which indicate to the animal that it will be given a reward if it brings back the article in good time.
That the brought-back article can automatically reach the dispensing device from the take-back device.
That the treat dispenser can give out reward food or else other attractive articles, for example toys.
That it has, as a retrieval device for animals, an ejecting device for articles, a take-back device, and also a reward dispenser which are connected to one another directly, via cables or radio.
That a timer or timing circuit can pertain to the device which measures at a predefined time the bringing-back in good time.
That the ejecting means can be located at an elevated site and is capable of periodically giving out articles, operates independently or is connected to the returning device and the treat dispenser via cables or radio.

B. A further variant of an animal training device will be described hereinafter: This is a device which encourages dogs, in particular sheepdogs, to move back protruding articles, which is then rewarded.

Sheepdogs have been bred to keep a group of other animals together in a flock. If an animal strays from the formation, then the dog drives it back into the flock. This group of dogs are very hard-working, they love correcting and performing tasks. It is even possible to observe how a sheepdog, when out on a walk and off the leash, runs around its family in order to keep them together. If the dogs are not used to work as sheepdogs, they soon become underchallenged, and this makes them very unsatisfied. Many people do not manage, for time and other reasons, to give the animals the required movement and activity. A system is therefore proposed which at least intermittently challenges the dog in a species-appropriate manner without the need for human presence.

The animal trainer consists of a system of drawers (S1, S2, S3) which move out in alternation; this is intended to prompt the dog to shove them back using its nose or paws (FIG. 5). This simulates the behavior of the sheep in a flock of sheep, where sheep that stray are driven back again and again into the flock by the sheepdog. In order for the dog to learn and enjoy performing these activities, it must always or occasionally be given a treat as a reward. The whole procedure can be operated and controlled electronically (electronic controller E), including by means of a timer Z1, as a result of which a drawer is moved outward again and again by an electric motor EM. If the drawer is then pushed back, or pushed back within a time defined by a second timer Z2, then the animal is given a treat L by a treat dispenser Le which is directly integrated into the device (FIG. 5) or connected by cable or radio contact. The treat dispenser can also be located on the animal's collar. The device requires for this purpose a transmitter and the treat dispenser requires a receiver for the radio signal.

With regard to the timers, it should be mentioned, in principle for all the devices proposed in this application, that obviously a modern timer can also control various time intervals, so that instead of two timers only one is necessary. The entire time setting can of course also be controlled by a chip, so that the owner carries out the adjustments merely on switches. All variants of a modern timing circuit of the various processes are therefore possible.

It is possible for the entire device to be embodied preferably for sheepdogs but also as a purely mechanical construction, where the mechanical shoving-back of a drawer triggers a mechanism which mechanically releases a treat. There may be provided at most a timer which is wound up by the shoving-back of the drawer and then, after a time to be set, releases the drawer again. An example is shown (FIG. 6). The treat dispenser Le contains a cylindrical food item Fu. This is pressed downward at all times by the spring F1. At the bottom, the flap KL first blocks the outlet. If, however, a piece of food (treat L) is now cut off by exerting pressure on the blade Sch, then the flap KL which is pivotably attached at the point D opens at the same moment, so that the cut-off food item L can fall outward.

The movements of the blade Sch for cutting off the food item and also of the flap KL are coupled via the linkage assembly G1 to the returning movement of the drawer S. At the same time, the linkage assembly G2 causes a mechanical or battery-operated timer Z to be wound up or activated. The drawer is pushed back by the animal counter to the spring force F2 and engages in the end position with an engagement element ER. After the end of the time defined by the timer Z, the engagement of the drawer is mechanically released again, causing the drawer to be pushed outward by the spring force F2, as a result of a connection V of the timer Z to the engagement element ER (for example by a spring 3 which was tensioned as a result of the pushing-back of the drawer, or by a linkage assembly 3 which carries out a movement after the timer has run down). At the same time, the blade Sch is also withdrawn and the flap KL is closed, so that the food item Fu is pushed further downward (V=spring F3 or linkage assembly G3).

Summarizing statements and possible configurations of this variant of an animal training device (sheepdog drawer):

That it is characterized in that an opening drawer can be pushed back by the animal, and in that as a result a treat dispenser which is present is stimulated to deliver a treat.
That the device can be controlled by an electric motor and has timers.
That the treat dispenser can be integrated directly into the device or is connected to the other parts of the device via cables, or else is connected via radio and can then be located also on the animal's collar.
That the device can be constructed purely mechanically, and in this case the process of pushing back the drawer automatically activates a treat delivery mechanism and also a timer.
That the device can be controlled by an electric motor and has timers which regulate the times of operation of the device, but can also be wired in such a way that only rapid completion of the task is rewarded.
That it is controlled in such a way that a treat dispenser renders accessible a food ration when an extended drawer, etc. is pushed back by the animal.
That it is characterized in that an opening drawer or another issuing element can be pushed back by the animal, and in that as a result a treat dispenser which is present is stimulated to deliver a treat.

C. A further variant of an animal training device will be described hereinafter: This is a device in which desired behavior of an animal is detected by means of sensors and is then rewarded.

Treat dispensers LS for delivering portions of treats, which are fastened on the collar H or breast harness of an animal, are known from DE 10 2005 021 878.4 (FIG. 7). Different internal or external signal transmitters can cause the electrically operated dispensing mechanism to cast a treat from the treat dispenser L before the dog's legs.

When a dog is given a reward, it always associates the moment at which the treat is given to its behavior at the moment at which the treat is delivered. In other words, it will be keen to display this behavior in the future. It is thus possible to attain training effects even without the dog keeper having to be present.

Thus, the presence of a dog in a specific location (for example in a specific part of the garden) could lead to it being given an increased number of treats. All that is required for this purpose is a sensor system. Possible examples of such a system include motion detectors or light barriers. Alternatively, a chip C, which is read by detection systems, is fastened on the dog's collar. The detection system can in this case be configured like an electric fence EZ (FIG. 8). The chip C and treat dispenser LS can in this case be combined in one apparatus.

It is detected whether the animal resides at a specific location at the measurement moment or during a time interval, and it is then given a treat. Alternatively, in the converse case, it is given a treat when it is not in a specific measurement area. As a result of the fact that the treat dispenser LS is fastened on its body, it is always ensured that the treat is administered close to the fence. It is also ensured that only one treat dispenser is ever required, regardless of when and where the dog is to be given a reward. Additional electronically integrated timers allow the sensor system to be activated for example only at specific times and for specific time intervals. Alternatively, it is measured that the chip C has had no contact with the fence EZ for a certain time, and then a reward is administered. The system therefore operates with rewards and in this way imparts to the dog in a gentle manner over the long term a correct behavior. It can therefore serve to prevent for example a dog from leaving the yard if it realizes that its only chance of being given a reward is if it stays on the yard.

It is also conceivable that an animal having a chip on its collar must pass through a specific course, and only when the chip has been recognized in all stations is a treat or a reward in the form of the release of a toy automatically given. All technically known methods for detecting the animal's position are of course possible, for example motion detectors which are also combined electronically with time measuring means or timers. The animal is guided through the course by an enticement system consisting for example of light signs, sounds, moving articles, recorders with recordings of the owner's voice. Another possibility would be to fasten on the animal's body sensors which detect specific postures, such as for example when the animal holds its head up (for example inclination sensors), at least intermittently (controlled by means of a timing circuit or timer) and then give out more rewards. Preferred movements or sequences of movement or distances covered can also be detected by means of suitable integrated sensors and measuring apparatuses and rewarded. Pedometers, vibration measuring apparatuses, etc. are known. A further sensor could be a sound recognition module which is integrated into the treat dispenser and ensures that a treat is released after specific noises or else spoken words.

Summarizing statements and possible configurations of this variant of an animal training device (rewarding of desired behavior):

It is characterized in that a treat is released from the treat dispenser after a radio command only when sensors detect a desired behavior.

Furthermore, provision is advantageously made for position detecting sensors to detect in combination with timers the presence of the animal at a specific location in a specific time interval.

In an advantageous configuration of the invention, provision is made for sensors to detect the completion of a desired course.

In an advantageous configuration of the invention, provision is made for sensors to detect the posture, body movements and movement intensities.

In an advantageous configuration of the invention, provision is made for sensors to detect sounds or specific words.

Further statements:
That it consists, for rewarding a desired behavior, of sensors and measuring means for detecting the behavior, which are connected to a treat dispenser via radio or in a constructional unit.
That sensors for detecting behavior can be present in combination with timers which detect the animal's behavior in a specific time interval or at a specific time measurement point.
That sensors for detecting position can be present and connected in combination with timers which detect the presence of the animal at a specific location in a specific time interval or moment.
That elements can be fastened on the animal's collar and be recognized by a system located in the environment and thus detect the animal's position, and that there may be an electric circuit which causes a treat to be given out when the system located in the environment has not registered the element located on the animal's collar for a specific time.
That sensors, for example inclination sensors, motion detectors, can be present and detect the posture, body movements and movement intensities.
That the treat dispenser does not have to be fastened on the animal, but rather can also be located in the animal's environment.
That, owing to the construction of the treat dispenser, ejection of treats, which is controlled by electric measuring systems, is possible only in the event of desired behavior, and that this can also be time-limited.

D. A further variant of an animal training device will be described hereinafter: This is a device which is preferably purely mechanical in its construction and gives more rewards for correct movements and postures of an animal.

A small treat dispenser L which is fastened on the animal (preferably on the collar H or breast harness) has the advantage that the ejected treats land in the immediate environment of the animal, so that it is easy for the animal to find and eat them (FIG. 9). The animal, for example a dog, will experience positively the moment when the food appears and will associate this with its behavior at this moment. It will therefore be best off displaying this behavior again and again: then it will always be rewarded, or at least it will be rewarded much more frequently than if this behavior is not displayed. Particularly advantageous are constructions, of which the detection of the desired behavior and of which the giving-out of the food are possible even without an electric drive, as this is less expensive. Thus, the construction can be configured, for example by means of obstacles Hi, in such a way that an opening Of for the issuing of treats is located only at one point of the dispenser, so that the dog will over time for example realize that it is given a treat Le only when it for example holds its head up (FIG. 10). That is to say, in the case of a specific posture, many more treats are dispensed for the animal owing to the mechanical construction. This could be used to urge the dog preferably to assume a specific posture.

Mechanical constructions which increase the probability of food being ejected, the more the animal moves, are not entirely random either. The more vibration and motion predominates, the sooner a treat will be dispensed. Thus, the more the animal moves, the more rapidly the treats will for example simply pass from the chamber K through the barriers B to the opening Of and leave the dispenser (FIG. 11). A large number of comparable mechanical arrangements of this type are possible. The advantage of the treat dispenser fastened on the animal is simply that the animal always immediately registers the rewarding. In principle, the animal is encouraged to move more (for example in the garden), as it unconsciously perceives the relationship between more movement and more treats. Instead of the mechanical arrangements, use could of course also be made of a large number of electric sensors (for example inclination sensors, vibration detectors, etc.), electric drives and controllers. In this case too, it is of course also possible for the activation of the measuring systems to be coupled to specific time intervals.

Summarizing statements and possible configurations of this variant of an animal training device (rewarding of desired movements and postures):
That, as a result of the suitable arrangement of the openings for the issuing of treats and also of other barriers and obstacles, treats are given out, or at least many more treats are given out, only in the case of a desired posture or body movement or a desired movement intensity.
That it can have elements for fastening on the animal's body.
That sensors, for example inclination sensors, motion detectors, can be present which detect the posture, body movements and movement intensities and are connected to the treat dispenser via an electric system, thus bringing about the giving-out of treats.
That, owing to the mechanical construction of the treat dispenser, more treats are ejected in the case of specific postures, movements, movement intensities.
That, owing to the electromotive linking of the sensors and the treat dispenser, more treats are ejected in the case of specific postures, movements, movement intensities.

E. A further variant of an animal training device will be described hereinafter: This is a device which rewards dogs for not barking.

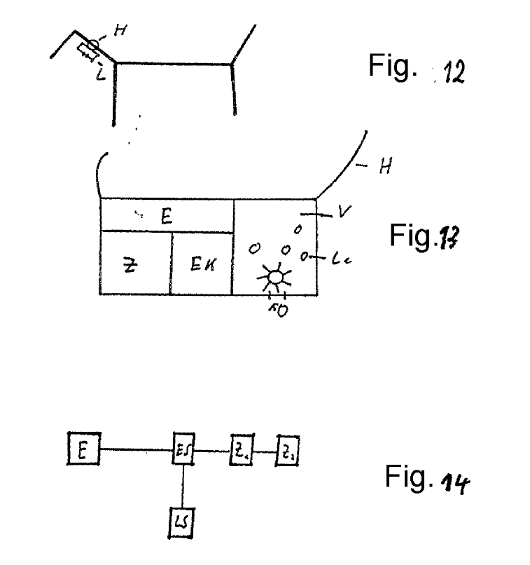

A small treat dispenser L which is fastened on the animal (preferably on the collar H or breast harness) has the advantage that the ejected treats land in the immediate environment of the animal, so that it is easy for the animal to find and eat them (FIG. 12). The animal, for example a dog, will experience positively the moment when the food appears and will associate this with its behavior at this moment. It will therefore be best off displaying this behavior again and again: then it will always be rewarded, or at least it will be rewarded much more frequently than if this behavior is not displayed.

DE 10 2005 021 878.4 and DE 20 2006 002 067.5 describe arrangements as to how the administration of reward food for animals can be controlled by a treat dispenser fastened on the animal. This can be carried out on the one hand by a human using a remote controller which he has in his hand. Alternatively, the behavior or the position of the animal is detected for example by sensors which then transmit a radio signal to the treat dispenser. Also described were devices which do not require a radio controller, but rather the sensors or signal transmitters of which are also fastened on the animal, and are directly connected to the treat dispenser, or are directly integrated therein. Thus, the intermittent giving-out of treats can be set in advance by the owner using a timer or be controlled by means of a random generator. Alternatively, delivery is carried out after mechanical contact.

An innovation to a reward treat dispenser fastened on the animal with a controller, also located on the animal, as a trainer for correct behavior will now be proposed. Commercially available anti-barking collars are intended to prevent dogs from barking when the dog keeper is not there. The dog's barking is registered by a modern detection technology (acoustics, vibration). As soon as the barking is registered, a cold air blast or even an electric shock is administered to the dog as a punishment.

A positive, reward-oriented, independently operating device would have the following appearance (FIG. 13). All elements of this illustration are integrated in one device, which is fastened on the animal's neck by means of a collar H, and are controlled by electronics ES.

The detection technology E is controlled by a timer Z1 which causes the detection technology to be switched on for example only every 20 minutes. It then remains in operation, also controlled by said timer or another timer Z2, for example for 1 minute. If the dog does not bark in this short time, then it is given as a reward a treat Le from the store chamber V, which leaves said store chamber through the opening O. Even if the dog does not even notice when the detection technology E is activated, it will over time realize that it is simply given more treats when it is quieter, and it will also realize that it has never been given a treat immediately after barking. The dog is therefore taught in a gentle manner to bark less.

If the detection technology E is able to detect the barking even at a certain distance, for example within a room, then the entire device can also be fastened for example on a wall and would not have to be carried by the animal. If the device is from the outset not intended for use on the animal, then the entity as a whole can also be designed to be larger. The time intervals (switching-on of the detection technology, duration of the activation of the detection technology) can be set individually by the dog keeper, depending on the dog and situation. It would also be possible, once the timer has activated the detection technology E, for said detection technology to remain operative until the dog has not barked for one minute, and then a treat is certainly administered. In this case, that which was stated hereinbefore applies: instead of two timers, all currently known time control modules (for example chips) can of course be used.

Summarizing statements and possible configurations of this variant of an animal training device (rewarding dogs for not barking):
That a food dispenser is connected together with a technology for detecting barking of the animal, and also one or more adjustable timers.
That it can be fastened on the animal, preferably on the collar or breast harness.
That the detection of the barking, the controller and also the ejection of the treats are electrically controlled.
That they can also be used located in the area.
That a reward food dispenser which is fastened on the animal's body or located in the area rewards, together with a technology for detecting barking, and also of timers, a dog for not barking.
That excessive vocalizations are prevented in that a food dispenser is connected together with a technology for detecting barking of the animal, and also one or more adjustable timers.
That a reward treat dispenser which is fastened on the animal's body or located in the area rewards, together with a technology for detecting barking, and also of timers or timing circuits, a dog for not barking.
That the timers or timing circuits which are present in the device can define an interval in which non-barking is rewarded during the time interval.
That a treat dispenser renders a food ration accessible when a noise sensor has not been activated over a certain time.

F. A further variant of an animal training device will be described hereinafter. This is a further device which rewards dogs for not barking.

Commercially available anti-barking collars for dogs are intended to prevent dogs from barking when the dog keeper is not there. The dog's barking is registered by a modern detection technology which is fastened on the collar (acoustics, vibration). As soon as the barking is registered, a cold air blast or even an electric shock is administered to the dog as a punishment. It would of course be equally conceivable for the dog's barking to be detected by a noise sensor which is located in the area and for a process which is unpleasant for the dog, for example the emitting of high-frequency sounds or the generating of other rattling noises, then to be triggered in an electronically controlled manner. These would all be methods which operate by punishing excessive behavior. A positive, reward-oriented, independently operating device would have the following appearance. The modern detection technology E (for example noise sensors) detects the vocalization as soon as it exceeds a specific adjustable degree (FIG. 14). This detection technology is connected to two timers by means of an electronic controller ES. The first timer Z1 determines the time lags after which the detection technology is repeatedly switched on. The second timer Z2 determines how long the detection technology is then switched on for. If no vocalization is registered in this time defined by the second timer, the animal is given a reward, be it by a treat dispenser L or in that a toy is provided.

Alternatively, the electronic time controller ES is set in such a way that the second timer operates until no vocalization is registered during a specific time interval to be set (for example 1 minute). Only then is a treat administered to the animal. Alternatively, the timing circuit of the device is set so as to operate all day long, and whenever no excessive vocalization is registered for example for 5 minutes, a treat is given out. It is also possible for the time intervals additionally to be indicated to the animal by way of additional signals, such as for example light signs, acoustic signs, mechanical indicators, etc.

The individual elements (detection technology, timers and reward dispensers, signal transmitters) can be located in one apparatus; they can however also be individual elements which are connected to one another merely via cables or radio. The treat dispenser can in this case also be fastened on the animal, so that the animal is given the treat always close to its mouth. Instead of timers, all modern time controllers, for example by means of a chip, are of course also possible as in the case of all variants mentioned in this application.

It is on the other hand also possible for only the detection technology which is already commercially available to be located on the collar, in this case in the form of a transmitter which sends a radio signal to a treat dispenser which is located in the area and has a receiver. This treat dispenser is controlled electronically, wherein it is possible to set via a timer that if the detection technology does not report a vocalization for example for 5 minutes, then a treat is delivered. The animal will learn over time that there are rewards only when it is not being noisy. This will lead over time to generally quieter behavior.

Summarizing statements and possible configurations of this variant of an animal training device (rewarding dogs for not barking):
That it consists of an adjustable detection system for noises, and also of electronic controllers including timers for defining the mode of operation of the detection system, and that there is a corresponding reward element which rewards non-vocalization.
That all elements can be located in one apparatus, or else are connected to one another via cables and radio so as to be spatially separated from another, and are electronically controlled.
That all elements or individual elements can be fastened on the dog's collar.
That there can be signal transmitters which additionally indicate to the dog the time intervals.
That all elements can be located in one apparatus.

G. A further variant of an animal training device will be described hereinafter: This is a device which rewards defecation at sites intended therefor.

Animals, in particular dogs, can be trained to defecate preferably at specific sites. Depending on the conditions in various countries, dogs often spend all day in the garden, or are able at all times to leave the house H and enter the garden G. In this case, they urinate and defecate there as desired. However, they can equally be persuaded to do this in specific, smaller corners (dog defecating site KP), for example on a small area on which for example gravel has been poured. This has the advantage for the dog keeper that for example the feces do not touch the lawn, and are also much easier to remove from the gravel using a shovel (FIG. 15). It is also possible to set up a small composting site right there, so that decomposition takes place there. The dog owner teaches the dog by giving the dog particular praise when it does its business in the right place. The immediate administration of a treat when the dog has got it right is also a major learning aid in this regard. Unfortunately, the dog forgets over time where it must do its business if it is not rewarded therefor always or at least occasionally. As the dog keeper of course does not always wish to look out for the right moment, there is a need for a device which recognizes when the dog has done its business.

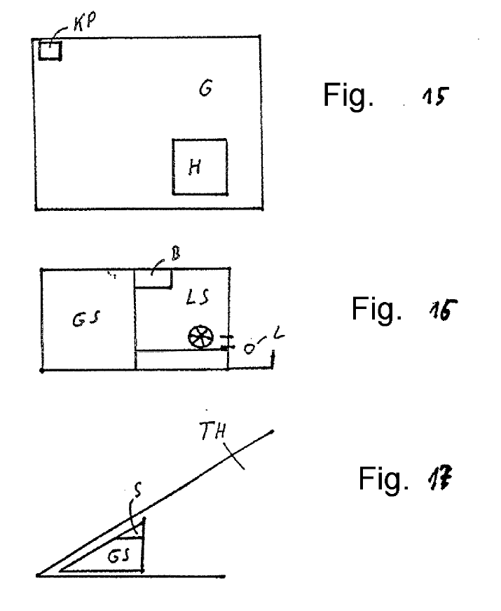

The device therefore consists of an odor sensor GS which immediately perceives the freshly deposited feces. The odor sensor is coupled to a battery-driven treat dispenser LS which thereupon immediately releases a treat L. The odor sensor and treat dispenser can be a unit which is powered by a battery B (FIG. 16). They can however also be connected via cables.

Alternatively, the battery-operated odor sensor is connected to a transmitter S which delivers a radio signal or infrared signal to a receiver E which is integrated in the treat dispenser LS. The treat dispenser can be located in the immediate vicinity, or it is a treat dispenser carried on the collar. The treat dispenser can in this case be suitable for delivering portioned amounts of food, but it can also be designed in such a way that it gives out all of the food during an opening process.

In order to allow the odor to be perceived by the sensor particularly effectively, bordering UR of the defecating site KP with walls standing obliquely inward is recommendable. These walls ensure that the odor is more concentrated in the corners. It is however also possible for the bordering to consist of upright walls. The odor sensor can however also be located in a funnel-shaped cavity TH, so that this entire unit can be deposited in a corner of the bordering (FIG. 17, FIG. 18). The sensor is located preferably in a selected corner of the walls (the preferred wind direction is taken into account). The treat dispenser can for example be very well-positioned, protected from wind and weather, at the output A of the system as a whole.

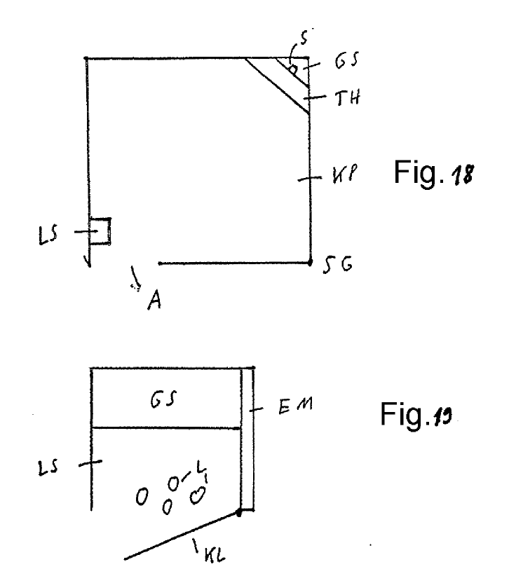

The odor sensor is set with regard to its sensitivity in such a way that it reacts only to freshly deposited feces. When it has then caused the ejection of a treat, the odor sensor is automatically switched off for a few hours, controlled for example by a timer or timing circuit. This saves energy and ensures that the sensor does not react twice to the same defecation. In order to cause the dog to defecate in the desired region, it is not necessary for it to be given a treat each time. Therefore, it may also be sufficient if the owner switches on the device only occasionally and once the odor has been perceived, a load of treats is poured out, whereupon the system as a whole is then switched off. For this purpose, the device can be designed very simply in such a way that there is located below the odor sensor GS the treat dispenser LS which merely has a flap KL which is closed by the owner once he has placed a load of treats L. Controlled by an electric motor EM, the activated odor sensor then causes the interlocking means of the flap to open and the entire content of the treat dispenser empties (FIG. 19).

In the case of a sufficiently small construction, the odor sensor and treat dispenser could also be located as a unit on the animal, for example fastened on the collar or breast harness. The owner would thus be able to fasten the device on the dog only from time to time. Nevertheless, an additional detection system, for example a light barrier, would then have to detect that the dog has entered the dog defecating site, and only then is a treat administered electronically or in a radio-controlled manner, on response of the odor sensor. A treat dispenser which is fastened on the animal and receives via radio the signal to empty its entire content can even be designed so as to be very much smaller. This applies most particularly if it is able only to release a single treat.

The dog keeper obtains access to the site by for example opening the walls using a hinge joint SG (FIG. 18). Alternatively, he does not have to enter the site at all, as he can, on walking around said site, remove the deposited dog feces at all points via the bordering UR using a long shovel. The site can be roofed, but should be open to the sides so that the odor can ultimately escape. As a result of the fact that the dog is again and again given a treat immediately after doing its business in the desired manner, it will be keen to seek out this site.

Summarizing statements and possible configurations of this variant of an animal training device (dog defecating site):
That it consists of an odor sensor for detecting defecation, which is connected to a treat dispenser.
That the odor sensor and treat dispenser can be integrated in one device.
That the odor sensor and treat dispenser can be connected to each other via cables or radio.
That timers can control the independent operation of the device.
That an animal is encouraged to deposit its feces at locations provided therefor, in that the device consists of an odor sensor for detecting the defecation, which is connected to a treat dispenser which causes the delivery of a treat.
That additional integrated timers or timing circuits can electronically control the independent operation of the device.
That a treat dispenser renders a food ration accessible when an odor sensor detects the defecation.

H. A further variant of an animal training device will be described hereinafter: This is a device which satisfies dogs' natural drive to dig, the dog being rewarded therefor.

Depending on their breed, animals, in particular dogs, have a differingly strong need to dig. This urge is particularly pronounced in terriers and what are known as ratters, i.e. generally small dogs. If the dogs are not given sufficient opportunities to dig, if for example they do not have their own garden, or digging is undesirable, or the owner does not want the dog to become dirty; then the dogs can become dissatisfied owing to inactivity. The proposed devices are intended to help animals to satisfy their digging drive, to some extent within the home.

A device is possible in which the dog uses its front legs to make a roll Ro rotate. The rotations of the roll Ro about an axis Ac are used by means of a drive An, for example in the form of a gear-wheel transmission, slowly to move a treat L, in a manner in which it can be seen by the dog, along a column Sa using a cylinder Z. Once the roll has been actuated for a sufficiently long time, the treat falls as a reward before the feet of the dog Hu (FIG. 20). The device can be actuated by the human in that he repeatedly introduces a treat into the column. Alternatively, it operates automatically in that for example the cylinder Z, after the ejection of a treat, is drawn back automatically, for example by a snap-action mechanism, into its starting position.

During this drawing-back, a treat L can also again be released into the column by a mechanically integrated treat dispenser LS. This causes the dog to “dig” again (FIG. 21). The game can continue in this way until the entire treat dispenser is empty. When the owner is not there, he can use a timer Z1 to determine when the first treat is administered. Equally, a second timer Z2 could be used to define in advance for how long the column is repeatedly topped up with treats before, for example, the entire digging mechanism is stopped. All types of timing circuits are of course also possible.

All types of devices (including for example a type of conveyor belt for the front legs) are therefore possible in which the dog activates, by movements corresponding to its sequence of movements during digging, a mechanism which then ends in the release of a treat. It would also be possible for the mechanism, if actuated for long enough, to transmit by means of a transmitter a radio signal to a receiver which then releases a treat from a treat dispenser. The treat dispenser can in this case also be fastened on the animal's collar. Alternatively, there is a cable connection between the mechanical part of the device and the food dispenser. This means that the device can also have electromotive elements, that for example the sufficient movement of a conveyor belt can also be measured by an electric circuit, and this be transmitted to the treat dispenser via radio, cables or an electric circuit.

Summarizing statements and possible configurations of this variant of an animal training device (digging roll):
That there is a mechanical element, for example a roll, which the dog moves with its front legs, and that there is a mechanism which is connected to the roll and causes a treat to be given to a dog.
That there can be a cable connection or radio connection between the roll and the treat dispenser.
That timers can be integrated into the device to allow an independent sequence of the device.
That an animal is rewarded for digging in that there is a mechanical element, for example a roll which the dog moves with its front legs, and that there is a mechanism which is connected to the roll and causes a treat to be given to a dog.
That timers or timing circuits can be integrated into the device to allow an independent sequence of the device.
That timers can be integrated into the device to define a time interval in which the animal can perform the task.
That a treat dispenser makes a food ration accessible once a mechanical unit has been moved sufficiently by movements of the dog corresponding to those during natural digging.

I. A further variant of an animal training device will be described hereinafter: This is also a device which satisfies the dog's drive to dig, wherein the dog digs immediately after the reward (for example treat, toy).

Depending on their breed, animals, in particular dogs, have a differingly strong need to dig. This urge is particularly pronounced in terriers and what are known as ratters, i.e. generally small dogs. If the animals are not given sufficient opportunities to dig, if for example they do not have their own garden, or digging is undesirable, or the owner does not want the dog to become dirty; then the dogs can become dissatisfied owing to inactivity.

The proposed device is intended to help animals to satisfy their digging drive, to some extent within the home. Devices are possible in which the dog digs immediately after the treat. One possibility is for example a trough W which is delimited by four lateral walls and in the center of which an elevation E is located (FIG. 22; FIG. 23). At least one side of the trough is filled with filling material FM (for example packaging padding material, textile remnants, etc.). Supply chutes ZS for treats L are located at the respective lower corners L where the user can alternately allow treats to roll under the filling material FM. Alternatively, the entire procedure is carried out automatically, even when the owner is not there, by a treat dispenser LS and timers Z. During digging, the dog will in each case convey the filling material FM from one side of the trough to the other side of the trough. As a result of the fact that treats are at all times administered, controlled by a small electric circuit, in ZS1 and ZS2 in alternation in a manner recognizable to the dog, the dog is encouraged again and again immediately to dig after the treat. The trough must be sufficiently large and tall that filling material FM does not escape, but on the other hand the dog can jump over the walls. It is however better for there to be located on one of the lateral walls a swing flap SK through which the dog can enter or leave the trough, but filling material does not escape.

Summarizing statements and possible configurations of this variant of an animal training device (digging trough):
That there is a trough, with two lateral depressions into each of which supply chutes for treats open, so that said supply chutes come to lie under the filling material located in the trough.
That supply of the treats can also proceed independently by way of electrically operated treat dispensers and timers.
That there can be a swing flap as the entry to/exit from the trough.

J. A further variant of an animal training device will be described hereinafter: This is a device which helps the dog to understand commands over long distances, the rapid fulfilling thereof being rewarded with a treat.

The animal keeper, in particular the dog keeper, influences his animal's behavior by issuing instructions. If the dog has visual contact with him, the dog also responds very well to visual signs, be it by hand or arm movements or other gestures. A possibility for directly giving a dog instructions without the keeper having to hear or see his dog is obtained merely as a result of the fact that the dog owner uses a remote controller. Previously known constructions include small apparatuses which are fastened on the collar and emit, once activated by the owner by means of remote control, sounds of differing volume, or even apply electric pulses or a cold air flow as a punishment.

The invention now to be presented seeks to give the animal instructions as a result of the differing positioning of transmission elements.

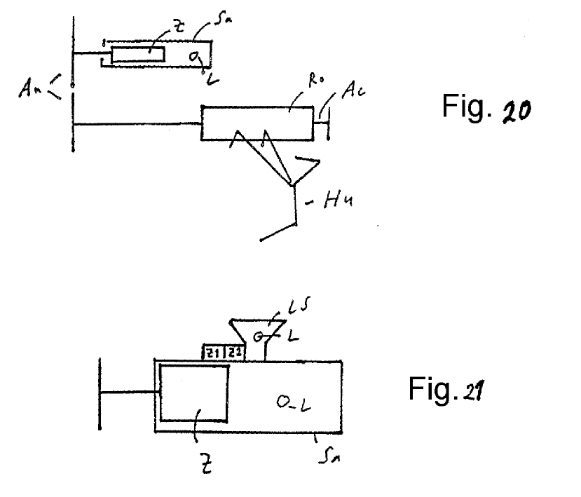

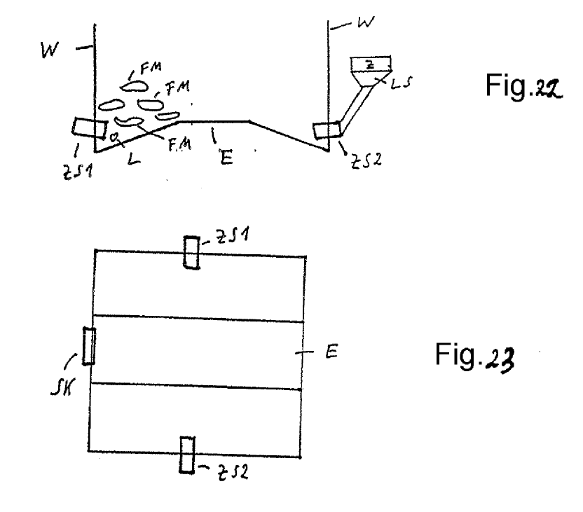

For example, it is not easy to make it clear to a dog running on ahead that it should run more to the left than to the right. Alternatively, it is necessary to impart to the dog that it should go more quickly or else more slowly. There are often problems also when learning new exercises, as the dog does not understand what it is actually meant to do (for example turn to the left). The remote controller allows in this case practicing at a distance. The device is in this case preferably attached not only to the collar, as said collar repeatedly becomes twisted during running. Fastening for example on a breast harness B is therefore better (FIG. 24). A breast harness consists always of a neck belt HG, a breast belt BG and also the upper connections OV or lower connections UV between the neck belt and breast belt. A conceivable possibility is that a conventional commercial strong breast harness which serves also to fasten the leash, on which the device can subsequently be fastened, or is already incorporated during manufacture. Another good option is however soft breast harnesses which are pleasant to wear and, although not sufficiently stable to fasten the leash thereon, are applied rapidly for example by means of a hook-and-loop closure, simply to attach the elements concealed therein of the device to the animal. Also known are breast harnesses B having merely recesses for the front legs AV, so that they can be applied rapidly by means of the hook-and-loop closures KV located at the end (FIG. 25). The battery-operated transmission elements UE can be incorporated very well and inconspicuously in these constructions which are pleasant to wear. A breast harness consists always of a neck belt HG, a breast belt BG and also the upper OV or lower UV connections between the neck belt and breast belt. The position of the transmission elements UE to be attached to the animal are preferably on the right and left body sides, and also at the top and bottom (FIG. 26). If the transmission element is activated on the left body side by means of the remote controller, then this would be for the animal, depending on how it has been taught, an instruction to go to the left or to go to the right. For the transmission element on the right side, the precise opposite is true. The upper or lower element would induce the animal to go forward, or to go slowly or stop.

The stimuli which the transmission element forwards to the animal would, depending on the actuation of the remote controller, be variable in their strength and number, and would accordingly also trigger reactions of differing strength in the animal. Depending on the dog's capacity to learn, further transmission elements would of course also be possible, for example two transmission elements on the upper side of the breast harness, the respective activation of which can then give even more targeted instructions. The purpose of the device is therefore not to punish the animal, so that the signals issuing from the transmission elements may never be such as to be unpleasant to the animal. On the contrary, they can be used easily to correct its behavior without the dog owner above all having to shout around from afar or the dog having to maintain visual contact with the human at all times. This can be used in dog training, specifically in dog sport, but also in working dogs. Particular effects could be achieved in the case of small tricks.

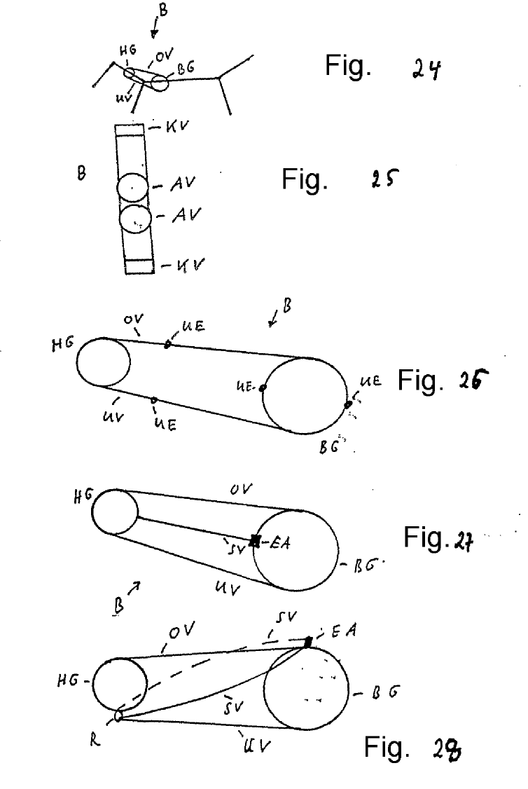

The positioning of the transmission elements UE at a broad range of points of the animal's body can in this case transmit a broad range of instructions (for example the activation of a transmission element located closest to the head could mean that it should let go of a toy in its mouth). The dog must merely learn in advance what the individual transmission elements require it to do. The previously known elements, which are fastened merely on the collar, for training dogs can give the dog instructions merely by generating stimuli of differing strength and type. In the case of the new invention, the type of stimuli can be the same in all cases; however, as a result of the differing positioning on the body, it allows a broader spectrum of the instructions to be transmitted. In this case, although the strength of the stimuli can also be varied, this is not essential, as the differing position of the transmission elements gives the dog enough information. After all, it is also always possible to demand intensified action by way of repeated actuation. The stimuli should therefore really be only quite weak, so that the animal does not start to fear the device; on the contrary, the controller should be just as harmless as when a human being gives acoustic instructions or visual signs. It would be conceivable for the transmission elements to generate for example slight vibration, such as for example in the case of a vibrating mobile telephone, or slight pressing or knocking; or slight poking of the animal in that for example a small bolt issues there from the transmission element. Slight heat or cold stimuli, for example as a result of an issuing gas or sounds or light stimuli emanating from the individual elements, would also be conceivable. Another possibility would be that the exerting of tensile force on the breast harness is able to control the animal. Thus, for example, a slight tensile force on one of the lateral connections SV between the neck belt and breast belt would be a sign that the animal should go toward this side (FIG. 27). This tensile force would have to be controlled by a small electric drive EA. Tensile force could also be exerted on connections to additional collars or dog holders. The lateral connections SV could also be fastened on the highest point of the breast belt, so that all that is located there is an electric drive EA which tensions either the right or the left lateral connection (FIG. 28). The fastening of the two lateral connections SV on the neck belt can then be on the ring R which is located at the lowest point of the collar. Tensile force on the left side will cause the dog to move to the left, tensile force toward the right causes, purely mechanically, movement toward the right. The two lateral connections SV are located in a protective tube, thus ruling out the risk of irritation of the skin or entangling of hairs.

The activation of the individual transmission elements should therefore be activated, as described hereinbefore, by a remote controller. The remote controller is activated by the dog keeper or could also be controlled automatically, for example in that transmitters emit a radio signal depending on where an animal is located; this can be ascertained for example by means of a motion detector. Apart from activation by remote control, direct mechanical activation as a result of touching by the human would also be conceivable, or as a result of the fact that there are integrated in the transmission elements modules which recognize individual spoken words and are activated as a result.

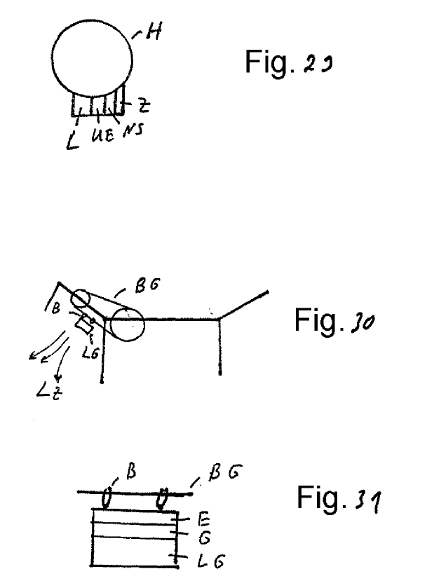

In addition, an electric circuit could check whether the animal, after receiving an instruction, carries the instruction out, and subsequently administer a treat to the animal as a reward from a treat dispenser carried along on its neck (FIG. 29). The transmission element UE, which can be fastened for example on the collar, therefore receives first from the remote controller an activation pulse. At the same time, a sensor located on the body, for example an inclination sensor NS, switched on via radio or by direct connection to the transmission element, is intermittently activated (timing circuit Z) and thus detects the desired movement of the animal (for example, in the case of the instruction “sit”, that the dog has sat down). If this movement is carried out, then the command to give out a treat is given, controlled by an electric circuit, to the treat dispenser L directly or via radio. The same thing could happen in the case of an already commercially available dog trainer by means of remote control, where a command is transmitted to the dog even over long distances (500 meters), for example during hunting. If, immediately thereafter (for example in that an activated timing circuit activates the sensors for, for example, 10 sec), it makes the demanded movement, a treat would be released, directly or via radio, from the treat dispenser carried along on the collar. Specifically during hunting, the dog is often left to its own devices, i.e. also outside the hunter's range of vision, so that the hunter could influence the animal using the disclosed arrangement.

A further possibility is to be proposed in order to give the dog an instruction over a greater distance without the owner having to call or make contact with his dog via visual signs (FIG. 30). A light emitter LG, for example a laser beam, carried fastened on the body, for example on the breast harness BG, by fastenings B, could be electrically controlled by the human via remote control. The laser emitter would as a result show before the dog on the ground light signs LZ which as a result give the dog instructions. For example, a laser beam to the left of the dog could inform the dog that it should go to the left. The light emitter LG receives the signal from the remote controller using its receiver E. The light emitter LG has a joint G allowing it, via remote control after receiving the signal, to move in various directions (FIG. 31). Thus, the dog is given instructions depending on where the light shines. A further possibility would be the emitting of lights having various colors or patterns. The animal's eyes cannot be struck by the light beam.

Summarizing statements and possible configurations of this variant of an animal training device (control by way of transmission elements):
That transmission elements fixed to different points of the animal give, as a result of their respective activation, various instructions to the animal.
That the transmission elements can be activated by means of remote control, direct contact or acoustic signals which are directly or indirectly generated by the human.
That stimuli are emitted by the activated transmission elements, so that the animal clearly perceives which transmission element has been activated.
That the stimuli are preferably stimuli acting on the skin (vibration, pressing, knocking, poking, heat, cold); tensile force acting on the breast harness, on the collar or on an additional collar or a dog holder; or acoustic or optical stimuli;
That an electric drive could exert a tensile force via connections (leather strap, rubber band, other bands) and that the connections are located in a protective casing.
That the transmission elements can be fastened or integrated preferably in a breast harness.
That commands are transmitted to the animal by means of an activation of transmission elements fixed to different points of the animal.
That the transmission elements are activated by means of an additional remote controller, direct contacting of a switch or acoustic signals which are received by a noise receiver.
That the transmission elements are enabled on activation to emit stimuli, so that the animal clearly perceives which transmission element was activated.
That a gas or warm or cold air, which is specifically perceptible to the dog, issues from the transmission element on activation.
That the transmission element can have a vibration mechanism.
That a small bolt, which gently strikes the skin, could issue from the transmission element on activation.
That there are sensors which are connected to the transmission elements via electric circuits, ascertain the carrying-out of a radio command and subsequently give to a treat dispenser which is also present the command to give out a treat.
That a treat dispenser carried along by the animal renders a food ration accessible when a command transmitted to the dog via radio is immediately carried out by the dog, this being registered by a sensor which is at the same time intermittently activated.
That it has an electrically controlled pivotable light emitter which is fastened on the animal and of which the different type or position of the light beam generated gives the animal signs.
That the animal carries on its body a light emitter which is controlled via remote control.

K. A further variant of an animal training device will be described hereinafter. This is a device which rewards rapid running to a demanded point.

Treat dispensers LS for delivering portions of treats, which are fastened on the collar H or breast harness of an animal, preferably a dog, are known from DE 10 2005 021 878.4 (FIG. 32). Different internal or external signal transmitters can cause the electrically operated dispensing mechanism AM to cast a treat from the treat dispenser L before the dog's legs.

There will now be described an interplay of systems which could induce an animal to run quickly back and forth. This could be a training effect for animals which are otherwise bored alone in the house or in the garden. Two elements are set up at a suitable distance from each other (FIG. 33). If the animal enters the range of action of the motion detector B of the element E1, then the transmitter S of the element 1 sends a signal to the receiver E of element E2 via radio or cables. As a result, the motion detector of element E2 is switched on and the enticement signal transmitter LS of the element E2 continuously emits enticement signals (for example sounds or light signs) which entice the animal. Over time, the animal will realize that it is worth running relatively quickly to element E2, because then a treat is always ejected from the treat dispenser L hanging around it. In order to implement this, element E2 contains a receiver E for the signal from element 1, and also a timer Z which is used to define how long the time is in which enticement signals are emitted by the enticement signal transmitter LS and in which the motion detector B is activated in element E2. If the animal enters the range of action of the motion detector B of element E2 within this time, then its transmitter S sends in turn a radio signal to the treat dispenser which is fastened on the dog's collar. As a result, the giving-out of a treat is caused there. By intermittently switching off and switching back on the motion detector in element E1, then the game can be restarted again and again.

Element E1 and element E2 can of course also be designed so as to be exactly the same and would then contain all of the described modules, so that they can mutually exchange their function in an electronically controlled manner. The dog must therefore run, in a time defined by the timer, from E1 to E2, or from E2 to E1, in order to be given the treat from the dispenser hung around it. The time interval in which treats can be called up can be set by prior setting by the animal keeper; or is controlled directly via a random generator contained in each apparatus, or by an external random generator via radio or cables.

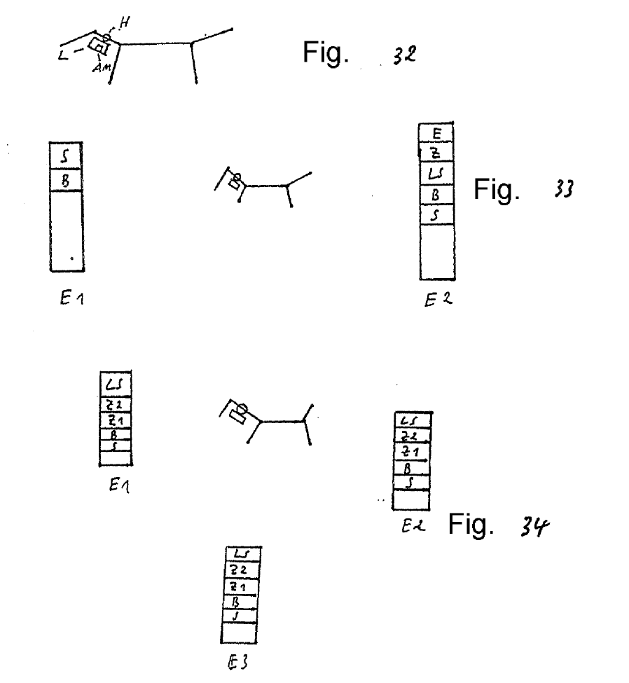

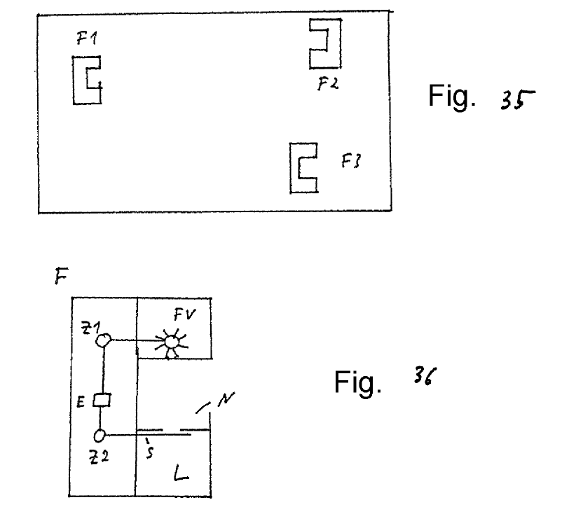

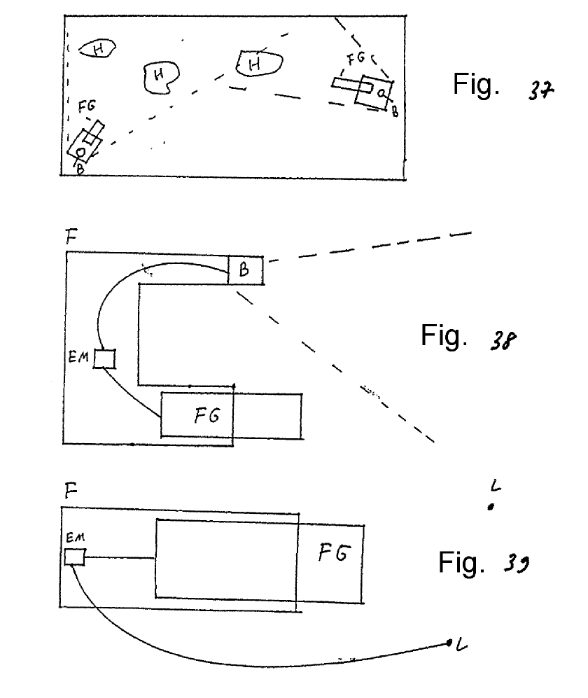

A further very advantageous arrangement would have the following appearance: three elements (E1, E2, E3) are located at various points in the area, and each begins, controlled by a respective timer Z1 after specific times (for example at an interval of A 10, B 15, C 20 minutes), to send enticement signals through the enticement signal transmitter LS and at the same time starts to activate its motion detector B (FIG. 34). The time interval for how long, in the case of each element, enticement signals are in turn sent and the motion detector is activated could in turn be set in advance by the dog keeper by way of a respective second timer Z2 in each dispenser (for example A 1 min, B 10 sec, C 30 sec). If the dog reaches the element while the enticement signals thereof are being sent and thus also the motion detector B is still active, then this element causes, by way of its transmitter S, a radio signal to be transmitted to the treat dispenser, so that a treat is then injected by the dispensing mechanism AM. In this way, it would never be possible for the dog to predict where the next treat will be given out, so that it cannot position itself accordingly. It is then enticed again and again by an element as a result of the sound and visual signals which are emitted and reaches this element, depending on the time interval set and distance, still in good time or else no longer in good time. The dog can learn that as long as the enticement signal is active, it is not yet too late to arrive in good time. This encourages it to speed up, as it notes that this improves its chances of a treat falling out of its dispenser. The two timers in each transmitter could be controlled also by a random generator: either in that a random generator of this type is located in each transmitter or in that a random generator controls all of the timers via radio. Alternatively, the timers or timing circuits are set individually by the human. Conceivable examples of position detection systems include above all motion detectors and light barriers.

However, the constructions used can be all known technical modules: for example video monitoring systems, camera systems having a monitoring function, alarm tread mats, differential alarm loops, time relays with magnet contacts, chip cards, RF transponders, magnet cards, heat detectors, vibration detectors, films with sensors, ultrasound echo distance warners, laser light barriers, additional time switches with a random program, a broad range of radio systems and wireless transmission systems having a broad spectrum of ranges and frequencies, wired systems with and without a socket connection, etc. The individual elements can be connected to one another by radio or cables; power is supplied via batteries or a socket.

As a result of the fact that the animal carries the treat dispenser with it, only one dispenser is required and not three, as would be the case if an individual dispenser were integrated in each element. It would however also be quite possible for the elements E1, E2 and E3 each to have their own integrated treat dispenser. This is more expensive than if only one treat dispenser is used, although as the elements are designed in the same way, production is not that expensive. The advantage would be that the dog registers more clearly that the quick running-around was worth it, as it then is given a treat from the treat dispenser to the element of which it ran quickly. A transmitter emitting a radio signal to the treat dispenser would no longer be necessary.

Summarizing statements and possible configurations of this variant of an animal training device (animal trainer for encouraging running):
That a treat is released from the treat dispenser, following a radio command, only when the animal has entered the range of action of a position detection system within a predefined time.
That two set-apart elements detect in interplay whether the dog has covered the intermediate distance sufficiently quickly, and then give out a treat.
That two elements are set apart, wherein one element has a motion detector, and a transmitter connected to said motion detector informs the second element via radio of the presence of the animal.
That two elements are set apart, wherein the second element has a receiver for the radio signal sent by the first element, whereupon its motion detector is activated for a time interval defined by the human or a random generator.
That two elements are set apart, wherein the activated motion detector of the second element registers the animal's approach and subsequently causes the treat dispenser to give out a treat, wherein the treat dispenser does not necessarily have to be located on the animal, but rather can also be integrated in the second element.
That two elements are set apart, wherein the activated motion detector of the second element registers the animal's approach and subsequently causes the treat dispenser to give out a treat.
That a plurality of mutually independent elements allow, at predefined different time lags for predefined different time intervals, a treat to be given out from the treat dispenser when the animal is in one of these time intervals, in the respective range of action of the position detection system.
That a plurality of mutually independent elements can release treats at different time lags for different time intervals and that these time lags and time intervals are controlled by one or more random generators.
That a plurality of mutually independent elements can release treats at different time lags for different time intervals and that these time lags and time intervals are controlled by one or more timers set by the human.
That the enticement signal transmitters of the elements can deliver acoustic signals (sounds, recorded speech of the owner, other enticing noises, etc.) or visual signals (light, colors, showing of motifs which the animal finds attractive, etc.) which are suitable for enticing the animal.
That signal transmitters indicate to the animal that it is worth running quickly, as then a treat is given out from a treat dispenser located on the animal or integrated in the element with the position measuring means, when the animal reaches the element, provided that the signal transmitters are still active.
That an animal is encouraged to run quickly to a set-up element in that a position detection system located in the element is activated for a certain time by means of a timing circuit and, on detection of the animal's approach, a treat dispenser integrated in the element is activated directly by an electric circuit or by means of radio to deliver a treat.

L. A further variant of an animal training device will be described hereinafter: These are configurations of devices in which food is offered only intermittently, and the animal is thus enticed and challenged.

a. Particularly suitable for dogs is in this case a device which allows the dog to reach the intermittently offered food if it runs up to the food quickly.

b. Particularly suitable for cats is in this case a device which entices the cat by intermittently displaying the food, but makes the food disappear again each time before the cat reaches it.

This development is intended to be a training aid for animals. In this case, the animals are intended to do something in order to obtain the food, just as happens in nature. The animal is challenged without a human necessarily having to be present. Food (a toy or other attractive objects) is/are rendered accessible, and before the animal reaches the food, it can be rendered inaccessible. It is also possible for the animal on occasions to reach the food or the article, although the article is then removed again and is ultimately no longer reachable. Obviously, the animal should from time to time also reach the food, so that it remains motivated. It is intended for all animal species, but in particular for dogs and cats. A broad range of constructions are conceivable. Depending on the behavior properties of the individual animal species, these constructions can also be modified accordingly. It is conceivable for 2, 3 or even more identical food dispensers (F1, F2, F3) to be positioned in an area and for each independently to give out food at specific times or after specific activations and to withdraw the food again, so that the animal cannot reach it, after specific times or after specific activations. In other words, the individual food dispensers can have no contact one with one another, each operating independently (FIG. 35).

a. Thus, for example in the case of a dog which is more geared toward rapid running, an arrangement would be possible in which each food dispenser has two timers. Timer 1 determines at what time lags a treat is given out and timer 2 defines how long such a treat is then available. This allows the owner to set the times in advance as he wishes. Thus, he can for example determine that the first food dispenser gives out a treat every 10 minutes and such a treat is available for 5 seconds, and that the second food dispenser gives out a treat every 5 minutes and such a treat is available for 15 seconds before it is withdrawn again. If two or more food dispensers of this type are set out in the garden or in the house, then the dog cannot estimate where and for how long the food will appear. It would also be possible for each dispenser to contain a random generator which determines and varies the times of the two timers at random.

Food dispensers which offer treats briefly and then make them disappear again after a short time, so that the dog cannot reach them, can have a broad range of appearances. FIG. 36 shows an example of a food dispenser. The electronics E control the sequences. Timer 1 determines at what time interval a treat falls from the food store vessel FV into the bowl N. Timer 2 determines how long it now takes until the slide S briefly opens, so that the treat falls into the space L. As each food dispenser operates at different time intervals, and the dog automatically is always located at a broad range of distances therefrom, it will again and again be able to snatch a treat and also now and again be unsuccessful. The dog is prevented from remaining only before one food dispenser as a result of the fact that it is each time a different dispenser containing a treat, supported by an optical or acoustic signal, so that the dog soon learns where a treat is released and is enticed thereto. It will learn that the quicker it runs to the treat which has been released, the more successful it will be. In principle, it is advantageous to use at least two identical food dispensers operating independently of each other. It is however also possible to maintain the entire operation using just one food dispenser. Thus, it would be conceivable, in the case of the arrangement with the timers, to select the time intervals of the providing of food to be so long that the dog generally no longer resides directly at the dispenser simply out of boredom.

b. In the case of other animal species, such as for example in the case of a cat, a fundamentally different construction of the same type of food dispenser would be conceivable, as a cat lurks and sneaks up more. Thus, it would in this case be better if, instead of the timers, a position measuring means, which detects where the cat is at any given moment, were integrated in each food dispenser. In this case, it is better for the food not to be administered or withdrawn gradually in portions, but rather to be made to disappear completely whenever the cat approaches. The procedure as a whole is then for the cat to approach again and again but never to reach the food. Nevertheless, there should then be in each dispenser a timer which switches off each dispenser after a specific time, so that then at this moment all of the food of the respective transmitter comes out and is thus available to the cat, as it were, as a final reward. Instead of the timer, a counter would also be conceivable, which after a specific number of sequences (for example the food has been offered 10 times) then also provides the food. The time interval or number of sequences is set by the human.

An arrangement with 3 food dispensers, each having an integrated motion detector B, could appear as in FIG. 37. The motion detectors B emit a specific area (indicated by broken lines). If the cat is registered by the motion detector, then the food vessel FG of this dispenser is drawn in by means of an electric motor EM such as a drawer, so that the cat can no longer reach the food (FIG. 38). Obstacles H placed by the human prevent the cat from being detected everywhere and cause, as a result of the alternating retracting and extending of the food triggered thereby, the cat to be encouraged again and again to make an effort. Obviously, the motion detectors must be oriented in such a way that they do not detect the movement of their own food vessel, as this would cause malfunctions.

It is of course also conceivable for the motion detectors or other position detection systems not to be accommodated directly in the dispenser, but rather to be connected thereto by means of an electric cable or else radio communication. In this way, motion detectors could for example also cover completely different areas and in this case control the food vessel at all times in such a way that the cat at first does not reach it. Alternatively, the position detection systems are constructed as light barriers (FIG. 39).

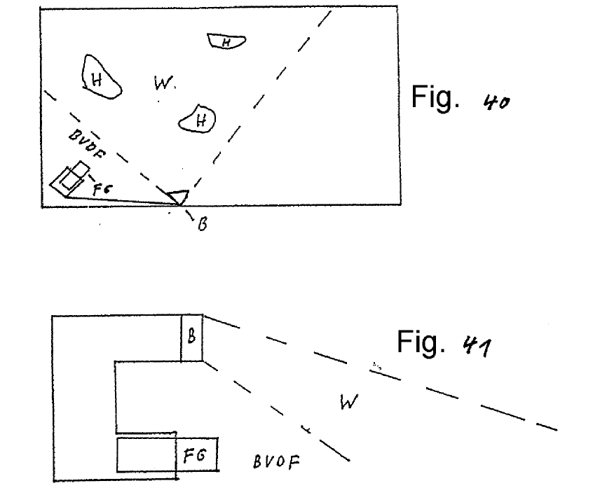

In principle, it is advantageous to use at least two identical food dispensers operating independently of one another. It is however also possible to maintain the entire operation using just one food dispenser. In the case of operation with position detection systems, an arrangement according to FIG. 40 would in this case be conceivable. As soon as the motion detector B registers a movement, the food vessel FG is in this case extended. As soon as the motion detector does not register anything, the food vessel FG is made to disappear. Obstacles H in the field of action W (indicated by broken lines) of the motion detector ensure frequently alternating movement of the food vessel. Equally, the motion detector itself could be designed in such a way or its viewing window merely masked in such a way that there are formed again and again in its field of action gaps where it does not then perceive movements of the animal. It is however important that a region before the food vessel BVDF is definitely not detected by the motion detector, so that the animal cannot for the time being reach the food vessel. For this purpose, the owner must position the motion detector in a suitable manner in advance. Alternatively, the motion detector is integrated straight away in the food dispenser (FIG. 41), if appropriate configured pivotably, so that its field of action W can be changed depending on the spatial situation. If the animal moves into the region before the food vessel BVDF, then the food vessel is quickly withdrawn, as the motion detector can no longer register any movement. A large number of arrangements with one or more position detection systems which may or may not be integrated in the food dispenser are possible in order to occupy the animal with one or more food dispensers.

Instead of motion detectors, also conceivable are all position detection systems and sensors known in the art: for example infrared detectors, video monitoring systems, camera systems having a monitoring function, alarm tread mats, differential alarm loops, time relays with magnet contacts, chip cards, RF transponders, magnet cards, heat detectors, vibration detectors, films with sensors, ultrasound echo distance warners, laser light barriers, time switches with a random program, a broad range of radio systems and wireless transmission systems having a broad spectrum of ranges and frequencies, wired systems with a socket connection, transponders on the collar, contact sensors, etc. In this case, a food dispenser can also have a plurality of external sensors, the reactions of which are then switched and evaluated and control the food vessel accordingly. The running time as to how long each individual food dispenser is operative before all of the food is provided can be set by the operator, for example before he leaves the house. In this way, it is also possible to control that the animal receives the first portion after one hour and another portion after 3 hours, etc. This also corresponds to the natural eating behavior of a cat.

Summarizing statements and possible configurations of this variant of an animal training device (intermittent offering of food):

a.
That a plurality of identical, mutually independent food providing means alternately render food portions accessible and subsequently, before the animal reaches them, inaccessible again, or else from time to time one (or more) of the food providing means renders food entirely accessible or renders it accessible long enough for the animal—in order to maintain motivation—to reach the food.
That two timers in each dispenser can control the sequence (moment at which the food is offered, duration of the provision of the food).
That the timers in each dispenser can be set in a fixed manner by the human.

Animal training device, characterized in that the timers in each dispenser can be controlled by a random generator.
That the timers in all dispensers can be controlled by a common random generator via radio.
That each dispenser contains two timers or one timing circuit which can control the sequence (moment at which the food is offered, duration of the provision of the food).

Animal training device, characterized in that the timers or the timer in each dispenser can be set in a fixed manner by the human.
That the timers or the timing circuits in each dispenser are controlled by a random generator.

b.
That each mutually independent food providing means contains one (or more) position detection system (or is connected to such a system via cables or radio) which ascertains the animal's position, and as a result the food vessel is offered by way of enticement and is made to disappear in good time.
That all technically known variants of the position detection means and sensors are possible, in particular motion detectors or light barriers.
That after a specific time or after a specific number of sequences, the food is provided to the animal.
That the animal is enticed again and again as a result of the use of a plurality of similar, mutually independent food providing means and also as a result of the utilizing of additional acoustic or optical signals.
That even if only one food providing means is used, if the position detection systems are arranged accordingly, a beneficial sequence can be brought about.
That the motion detector used can have a field of vision with gaps, and thus the animal is not perceived at certain points, so that the food vessel carries out irregular movements.
That each mutually independent food providing means contains one or more position detection system (or is connected to such a system via cables or radio) which ascertains the animal's position, and as a result the food vessel is either offered by way of enticement and/or is made to disappear in good time.
That only one position detection system, for example a motion detector together with obstacles in the area, is used and as a result irregular movements, which the animal is unable to calculate, of the corresponding food vessel are triggered.
That the field of vision of the motion detector can be partly concealed, or by virtue of its construction has gaps, so that there are again and again in its sphere of action areas which are not detected by it.
That a position detection system controls a food vessel, as a function of the animal which, as a result of obstacles or gaps in the field of action of a position detection system, is sometimes not detected, in such a way that said food vessel alternately is shown again and again and is made to disappear, and that the animal never reaches the food during the normal sequence.

It would also be possible for food or a toy to be offered, but then to be made slowly to disappear. For example, food or a toy is offered by a device which is fastened for example on the ceiling ZD. Once the food has been let down (for example fastened on a cord S), it is drawn upward (FIG. 42). Alternatively, the food or toy moves on a defined path, for example of a rail, where the animal can reach it only intermittently. The speed of the movement can vary. It is then also possible for the food finally to move into a cavity where the animal cannot reach it. It would in this case also be possible for, in the case of relatively stable constructions, the animal to reach the food or toy, but then to have to “struggle” therewith before it can eat the food or can play with the toy. If for example a toy is drawn upward, then the animal can try to prevent this by taking the toy in its mouth and pulling on it. Alternatively, the animal has to prevent a food vessel from disappearing into a cavity by clinging on to it with its paw. It should in this case be possible for the owner to set in advance the force and the speed at which the food or toy moves, so that there cannot be any unpleasant incidents.

Summarizing statements and possible configurations of this variant of an animal training device (digging roll):
That food or a toy is slowly drawn from a region which the animal is unable to reach, so that the animal must run quickly.
That the animal reaches the moving food/food vessel or toy, but can cling on to or tear it away only with extreme application of force.

M. A further variant of an animal training device will be described hereinafter: These are particular embodiments of a treat dispenser, specifically of a treat dispenser fastened on the animal.

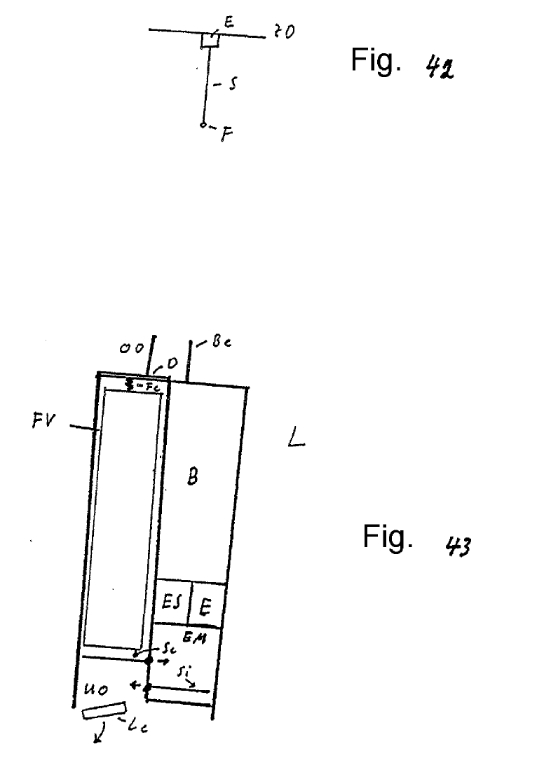

Treat dispensers have become known which are fastened on the animal's body, preferably on the collar or on the breast harness, and which deliver treats after a radio signal or as a result of another triggering signal. In this case, preferably portions of the food are cast from the dispenser before the front legs of the animal, preferably of a dog, thus allowing for example the animal to be rewarded with precise timing. Conventional commercial small dry food pellets often have the drawback that in the end the dog does not enjoy eating them so much after all. Also, the mechanism for the ejecting of the treats is not so simple either, as it soon becomes blocked, so that it is not easy to ensure the reliable giving-out of a treat on each radio signal. Therefore, from the point of view of construction, it may as a result be easier to prepare and to eject the treats in that the food to be given out is present first in one piece, and only ever small pieces are separated off from the large food item and ejected. In other words, the portioning is carried out only during ejecting. Relatively soft food is even more suitable for this method than hard food; this additionally has the advantage that the food is often more attractive for the dog and the dog training is as a result further facilitated. Different methods may be used for the separating-off of small treats from a large piece of food. In a preferred embodiment, the food has preferably a consistency such as is known from sausage, for example ham sausage or salami. Use may be made of all kinds of methods which are already known in the art and allow the separating-off of a small amount from a large amount: in the first case, of course, cutting-off, scraping-off, squeezing-out using a more or less sharp cutting tool, or simple dividing-off using a slide, etc. Predetermined breaking points can also already be present in the food item F. FIG. 43 shows an advantageous construction. The treat dispenser L consists in this case of a food store box FV containing a food item F (for example an appropriate piece of salami or other semi-moist food from a piece, etc.). This food can easily be introduced and added via the upper opening OO which is closed by the lid D. The food item F is always pressed downward as far as possible, regardless of how long the food item F is, by a spring Fe which is fastened on the lid. At the top there are also the fastening elements B for fastening the treat dispenser, for example on a collar. At the bottom there is a blade Se which, by horizontal advancement, cuts off a slice from the food item F. Once it has done that, then the cut-off the food item falls as a treat Le from the dispenser. This is facilitated, as the slide Si withdraws at the same time as or shortly after the cutting-off of the treat Le, as a result of which the cut-off treat Le falls out through the lower opening UO. In the next sequence, the slide Si then slides back under the food item F, so that after the withdrawing of the blade Se, the food item F is pressed downward by gravity and by the spring Fe until it rests again on the slide Si. Now the slide Si, triggered by the next signal, can cut off another slice, etc. The entire process is controlled electronically, by an electronic controller ES, powered by the batteries B. The means for triggering the cutting process can be for example a receiver E for a radio signal, but also other elements, such as sensors, timers, etc., depending on the objective. The electric motor EM moves the blade Se and also the slide Si. The precise configuration thereof is of course possible in a broad range of ways. The blade could also consist of rotating knives or of small scraping or excavating elements which convey small parts toward the opening uO. More solid substances, which are not so greasy that they stick to the wall, fall without difficulty from the dispenser once the slide Si has been opened. For reasons of space, a plurality of narrow food items can for example also be present and be arranged accordingly, so that they are processed one after another, for example by separating-off, to form treats, thus allowing longer dispensing.

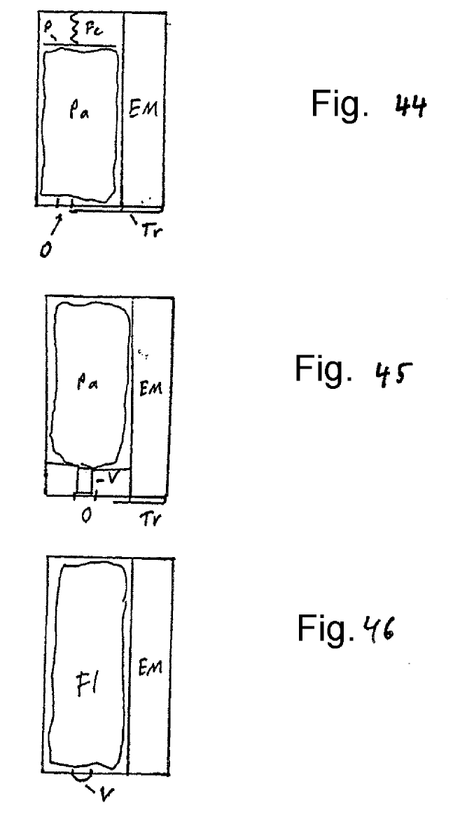

The food used can have all possible consistencies, from very hard to liquid. Very hard food in one piece allows at most cutting-off, or breaking-off, pushing-off of small pieces which are then ejected as treats. Predetermined breaking points would be advantageous in this case. A possible mechanism would also have the appearance shown in FIG. 43. In the case of medium soft food, mechanisms as shown in FIG. 43 are possible. Even softer foods, the consistency of which is paste-like, can be pressed toward the opening O by pressing from behind (spring Fe with plate P) or for example by means of a spiral as in the case of a meat mincing machine. There, they may be pressed simply through a sieve. Alternatively, if the paste Pa has a somewhat more solid consistency, the paste is simply advanced again and again over a certain distance, and a separator Tr then scrapes this piece down, so that it falls toward the ground (FIG. 44). As the paste has a somewhat more solid consistency, it remains in one piece even after the separating-off and can easily be taken up by the animal. The process as a whole is controlled again by an electromechanical arrangement EM. Alternatively, the paste is first used to fill a preportioner V which is then emptied on the next triggering signal. In this case, use may also be made of mechanisms such as are used in toothpaste dispensers. In the preportioner V, more intensive compressing to form a mass could also be carried out by a pressure-generating means (FIG. 45).

The food can even be present in entirely or almost liquid form Fl, so that it flows out, after intermittent opening of a closure V at the lower end of the dispenser, almost merely as a result of gravity (FIG. 46). The ordered issuing of the food liquid can of course also be carried out by corresponding valves and nozzles. In this case, it is also possible first to fill, by allowing the liquid to run in, a preportioner V (as shown in the case of the paste in FIG. 45) which is then emptied on the next triggering signal. Treats going specifically in the direction of the liquid can of course, when taken up from the ground, present problems to the animal if they connect for example to the earth. It would therefore also be beneficial to have, in the case of these treats, a supply device ZV which presents the given-out treats through a line, for example a tube Sch and a collecting vessel AG located at the end thereof, to the animal in such a way that it can take up the treat portion directly in its mouth from there (FIG. 47).

An embodiment for solid, small, precisely size-defined treats could be that they each lie, substantially as in a revolver, in its chamber K, and these are then successively expelled after signal triggering (FIG. 48). In this case, various signal triggerings are also conceivable, for example radio signals at various frequencies which each empty a difference chamber.

Further advantageous devices are intended to prevent the dog from having to take up the food from the ground; this is particularly advantageous for soft, paste-like or liquid foods. This is also advantageous because the dog is not so distracted from its activity at any given moment by the take-up of food if it does not have to search for the food on the ground. Thus, supply devices as shown in FIG. 47 are advantageous. These can also be extendable, so that they are not always located before the animal's mouth. Another possibility would be the attaching of a treat dispenser L to the lower front end of a breast harness B (FIG. 49). From there, the dog is then able to take up the food effectively using its tongue, in particular if the food is delivered into a collecting vessel AG, or generally the food is delivered upward or forward. Attaching the treat dispenser L to the lateral breast wall is also possible (FIG. 50). Corresponding mounts must be designed for the attaching of dispensers of this type, so that the treat dispenser fixedly assumes its position. Equally reachable is a front foot of the dog; attaching a treat dispenser there, for example using a hook-and-loop tape, will however restrict the dog excessively.

An advantageous attachment of a small treat dispenser L could also be carried out on what is known as a dog holder H which is applied to the animal's head. A treat dispenser could be attached laterally to the head, so that its opening O goes toward the mouth. A treat given out there, for example a piece of paste as from a toothpaste dispenser, would then be easy for the dog to reach using its tongue (FIG. 51). In this case, it would also be possible for a part of the dispenser, for example batteries, to be fastened on the collar, and only the actual dispenser to be fastened on the holder, so that the load is not so great there. The two parts would be connected via cables. Corresponding mounts must be designed for the attaching of dispensers of this type.

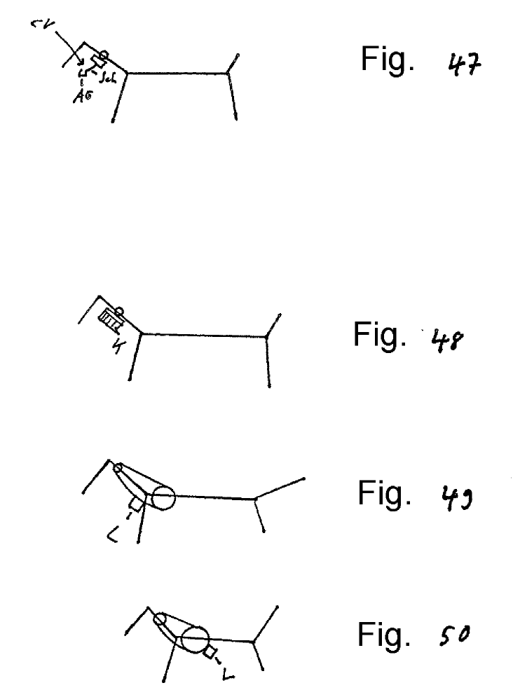

A further advantageous arrangement would be that the treat dispenser is designed and applied like a kind of loose muzzle, so that food delivered from the treat dispenser can be grasped directly by means of the tongue and lip without beforehand falling to the ground. This construction would be possible in the case of a dog, but also in the case of many other animal species (for example a horse). The muzzle M is fastened on the animal's head and neck by means of fastening bands B and contains an integrated battery or rechargeable battery-operated treat dispenser L which delivers treats, portioned by means of a dispensing mechanism, to the animal through the opening O. The portions delivery is caused by the animal owner by means of remote control (FIG. 52).

A further worthwhile aim of a treat dispenser fastened on the animal would be for the entire construction to be water-tight and even to allow the animal to jump into water. For this purpose, the dispensing openings must in particular be designed in such a way that they close off in a water-tight manner when closed. Obviously, this is easier to achieve in the case of liquid or paste-like food, but is possible in the case of all arrangements if corresponding elements (rubber seal, etc.) are provided. Then, the device would be possible also in the case of water-dwelling animals. A further advantageous construction could even provide for the supply of the food to be facilitated directly into the mouth, by for example a small, bent-over silicone tube Sch leading into the cheek pouch at a lip angle. This would be particularly advantageous for liquid or paste-like food (FIG. 53). It could even be applied in the case of water-dwelling animals.

A further advantageous construction of a treat dispenser would be the integration of a measuring apparatus or sensors which measure the state of filling of the dispenser with food and issue a warning signal or stop operation when the amount of food starts to run out. Of course, it is also possible to design the disclosed embodiments of treat dispenser in such a way either that they can be carried along by a human and can be triggered by hand or else that they are fastened not on the animal but rather in its environment.

Summarizing statements and possible configurations of this variant of an animal training device (embodiments of a treat dispenser):
That, after an activation by a signal transmitter, separating-off elements separate off small parts from a non-preportioned food item and suitable opening elements ensure that the treats then reliably leave the treat dispenser.
That electromechanical arrangements take over the controlling of the sequences.
That the dispenser can also have a button for manual triggering, and that it can also be carried along by a human for the convenient dispensing of treats.
That the consistency of the food can range from dry and solid to entirely liquid and that the individual treats are then separated off by way of suitable mechanisms.
That the treat dispenser as a whole can grasp only a single food portion which is released after signal transmission.
That the treat dispenser has a plurality of chambers for storing treats and these chambers are each emptied, one after another, after signal transmission.
That the treat dispenser has a plurality of chambers for storing treats, or even various mechanisms for delivering treats, and these chambers are emptied or these mechanisms activated, for example, in accordance with the triggering signal.
That the treat dispenser is designed in such a way that it allows, owing to its mounts and dispensing means, attachment to highly specific points of a breast harness or a dog holder or other points of the body or other objects fastened thereon.
That the treat dispenser is designed so as to be water-tight.
That it has a measuring means with respect to the filling state, with corresponding alarm means.
That it allows food to be taken up without the food falling to the ground.
That the treat dispenser is located in a muzzle, and thus the ejected food comes to lie directly before the mouth.
That the dispenser is fastened on a head holder, and thus the ejected food is brought directly before the mouth or directly into the mouth.
That it allows the food to be conveyed directly into the mouth.
That the treat dispenser is located in a muzzle, and food is released there directly before the mouth, to be taken up.
That the treat dispenser has a conveying unit which brings the food directly into the mouth.
That the dispenser is fastened on a breast harness which is fastened on the body using other fastening means, for example bands, in such a way that the animal can reach it using its mouth.

N. A further variant of an animal training device will be described hereinafter: These are further particular embodiments of a treat dispenser, specifically of a treat dispenser fastened on the animal.

Treat dispensers have become known which are fastened on the animal's body, preferably on the collar or on the breast harness, and which deliver treats after a radio signal or as a result of another triggering signal. In this case, preferably portions of the food are cast from the dispenser before the front legs of the animal, preferably of a dog, thus allowing for example the animal to be rewarded with precise timing. Conventional commercial small dry food pellets often have the drawback that in the end the dog does not enjoy eating them so much after all. Also, the mechanism for the ejecting of the treats is not so simple either, as it soon becomes blocked, so that it is not easy to ensure the reliable giving-out of a treat on each radio signal. Therefore, from the point of view of construction, it may as a result be easier to prepare and to eject the treats in that the food to be given out is present first in one piece, and only ever small pieces are separated off from the large food item and ejected. In other words, the portioning is carried out only during ejecting. Relatively soft food is even more suitable for this method than hard food; this additionally has the advantage that the food is often more attractive for the dog and the dog training is as a result further facilitated.

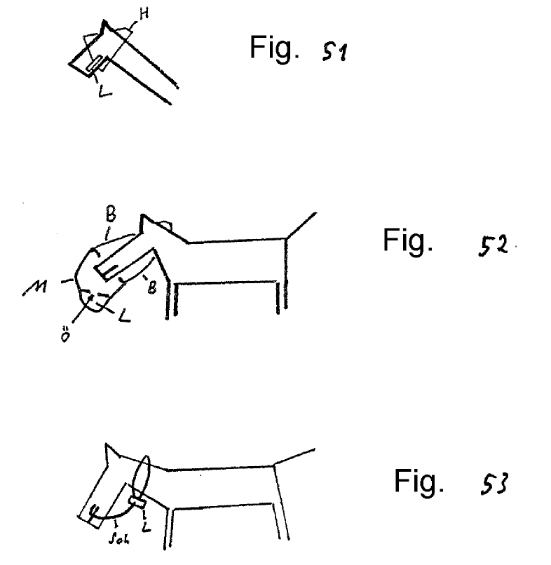

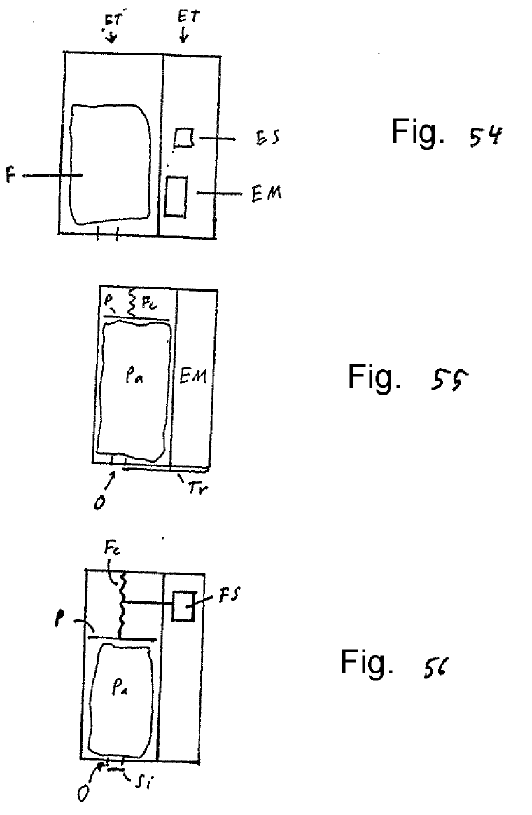

The treat dispenser consists of a part FT, in which the food and the food dispensing means are located, and an electric part ET, in which the electric controller ES and the electromotive elements EM are located (FIG. 54).

The food used can have all possible consistencies, from very hard to liquid. Very soft food, the consistency of which is paste-like, can be pressed toward the opening O by pressing from behind (spring Fe with plate P). In this case, the spring force acts permanently, and a separator Tr releases in an electrically controlled manner the opening again and again for a short time, thus allowing a certain amount of paste Pa to issue (FIG. 55). The separator Tr is in this case controlled by an electric motor, possibly also with the aid of a spring, so that said spring is pre-tensioned and then allows the separator Tr to move very fast. Alternatively, the spring force, electrically controlled by a spring force controller FS, will release a piece again and again (FIG. 56). In this case, the paste is simply pressed through a sieve Si, for example at the opening O. The energy for the pressing-out of the paste Pa or else a liquid or of more solid food can be generated by a spring or else by an electric motor EM (FIG. 57). It could however also be generated by a small gas pressure chamber GDK in the form of a cartridge which is integrated in the treat dispenser. This pressurized gas would, after electrically controlled partial release, press on the plate P and push the food toward the dispensing opening (FIG. 58). Alternatively, it would generate a permanently uniform pressure on the plate P, so that the portions delivery of paste would be produced again by the intermittent opening of a separator Tr. In this case, defined amounts of food can be prepared for ejection by the switching-on of a preportioner. It would also be conceivable for the food and gas to mix in that gas is added to the food via a valve Ve located in the wall W and then a food/gas mixture FGG is given out portion by portion (FIG. 59). The ordered issuing of, for example, food liquid can then be carried out by corresponding valves and nozzles or preportioners V.

Summarizing statements and possible configurations of this variant of an animal training device (embodiments of a treat dispenser):
That it has elements allowing food to be released portion by portion.
That it has elements causing advancement of the food portion by portion.
That it has elements which place the food under pressure; and additionally has elements for the intermittent release of the food via an opening.
That there is provided a gas pressure chamber, the energy of which moves the food piece by piece.
That there is provided a gas pressure chamber, the gas of which mixes with the food and then leaves the dispenser together therewith.
That there is provided an electric motor which pushes the food toward the dispensing opening.
That there are provided a spring and in addition a slide for the intermittent release of the pressurized food.
That there are provided a spring and a spring control device for the release of the spring force piece by piece.

O. A further variant of an animal training device will be described hereinafter: These are further particular embodiments of a treat dispenser, specifically of a treat dispenser fastened on the animal.

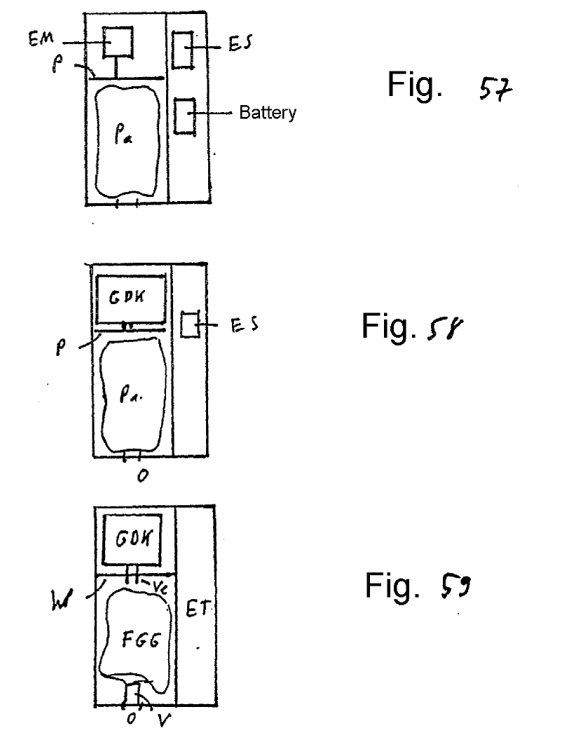

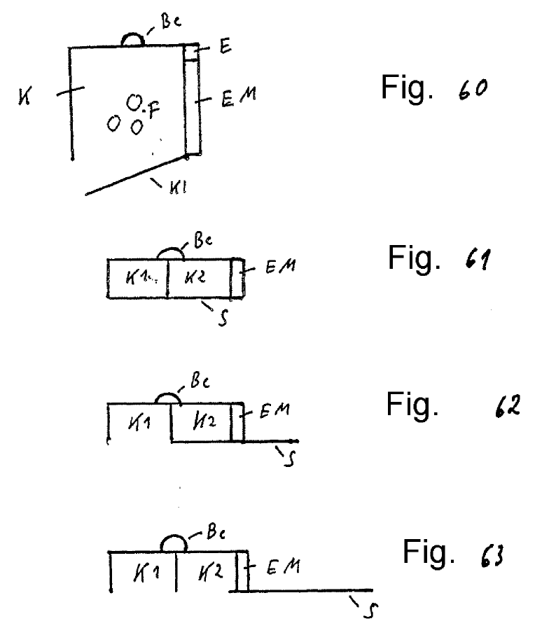

Treat dispensers have become known which are fastened on the animal's body, preferably on the collar or on the breast harness, by means of fastening elements Be and which deliver treats after a radio signal or as a result of another triggering signal. In this case, preferably portions of the food are cast from the dispenser before the front legs of the animal, preferably of a dog, thus allowing for example the animal to be rewarded with precise timing. In the case of conventional commercial small dry food pellets, the mechanism for the portioned ejecting of the treats is not so simple, as it soon becomes blocked, so that it is not easy to ensure the reliable giving-out of a treat on each radio signal. The design can therefore be restricted to merely one chamber K as the treat dispenser LS. Once a transmitter S has transmitted a radio signal to the receiver E of the treat dispenser LS, a flap Kl is opened by an electromotive means EM and immediately releases the entire food F. In this way, at least one administration of treats could be carried out at a distance (FIG. 60). If the chamber is so small that it can contain merely one or two treats, then this has the advantage that the device as a whole is kept extremely small.

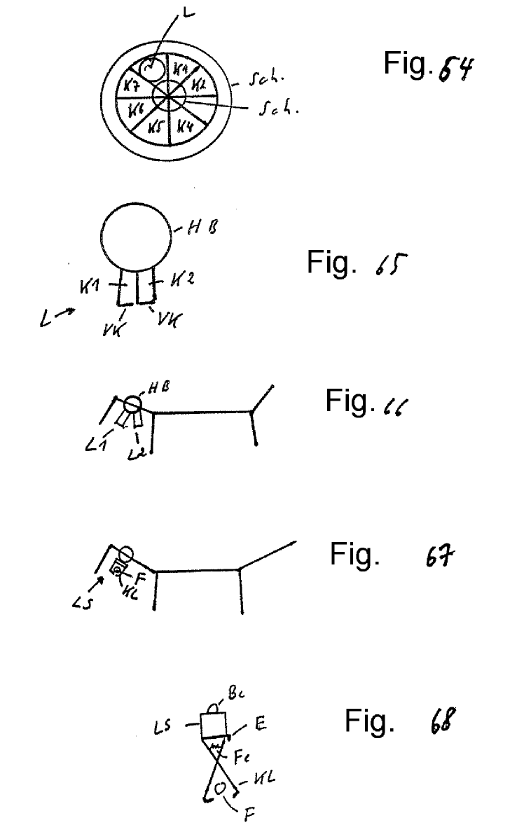

It would also be possible for the treat dispenser to consist of a plurality of chambers of this type, the chambers being successively emptied (FIG. 61). Thus, for example, a slide S would close first chamber 1 (K1) and chamber 2 (K2). On the first radio signal, the slide S moves, controlled by an electromechanical means EM, so far to the side that chamber 1 can empty (FIG. 62). On the next radio signal, the slide moves still further to the side, so that the second chamber also empties (FIG. 63). Equally possible are round arrangements in the case of which a disk Sch which is located below the circularly arranged chambers K1-K8 and has a hole L continues to move from chamber to chamber, so that one chamber after another always completely empties on each movement of the disk (FIG. 64). Equally, it is of course also possible for the chambers to move in a circle, and for the chamber located above the hole in the disk to empty in each case after each advancement.

Alternatively, each chamber of the treat dispenser L fastened on the collar HB has its own closure flap VK, wherein on each radio signal, controlled by an electric circuit, the next flap is in each case always opened, and the entire food F falls out. Alternatively, the closure flaps respond to various radio signals, so that the user decides using his remote controller which flap is to open. Therefore, each chamber has its own closure flap VK, wherein, depending on the radio signal, controlled by an electric circuit, only one specific flap opens at all times. If the treat dispenser has different-sized chambers each having its own flap, then the user can also decide that, for example by transmitting a radio signal having a specific frequency, instead of a small chamber K1, a particularly large chamber K2 is to open when the dog has done something particularly good (FIG. 65). There is therefore the possibility of graded rewarding.

Finally, it would also be possible in this way for there to be located, for example on the dog's collar, also a plurality of independent treat dispensers (L1, L2) which have a chamber and each respond to various radio signals (FIG. 66). Finally, it will also be possible for a portion of food F or a treat not to be located in a chamber, but rather to be secured for example only by a clamp KL or other holding or gripping element fastened on the collar. During opening of the clamp, the treat falls to the ground (FIG. 67). The clamp can also have a spring F as well as an engagement element E, so that it is tensioned when loaded by the human, and only then is the engagement element electrically opened (FIG. 68). Constructions of this type have the advantage that the food can be reloaded quickly. Equally, a storage chamber could, for example, have an opening toward the rear, thus allowing food to be rapidly added from there.

A further interesting construction of a treat dispenser L fastened on the animal will be examined hereinafter. An additional possibility would be an additionally built-in voice recorder V (FIG. 69) which, once the task has been fulfilled, in addition to the treat which is given out, also plays back praise recorded beforehand by its owner. The owner could decide by selecting various buttons (radio signals) on the remote controller whether only a treat is given out, or else treats plus praise by the voice recorder, in that the voice recorder is additionally activated. Alternatively, a small toy could also additionally be released. Equally, all previously known functional elements fastened on the collar could be integrated, together with a treat dispenser, into one apparatus. Equally, in the case of training exercises occurring when the human is not there, the reward can of course be graded, depending on the degree to which the requirements are met, by means of electronics of differently triggered radio signals.

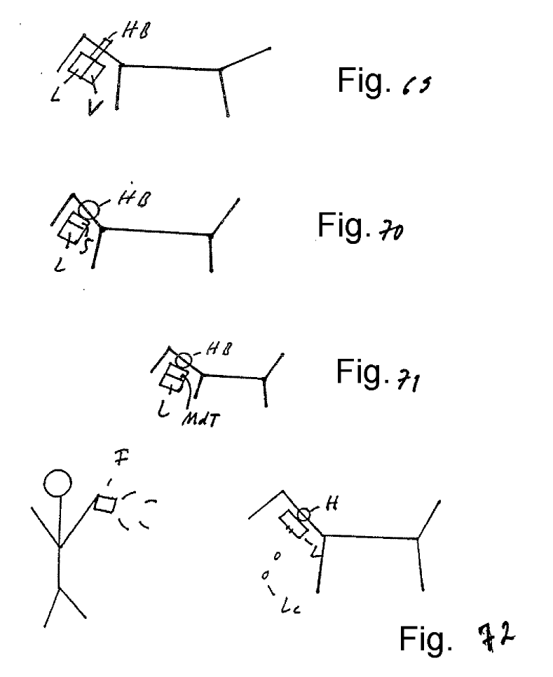

A further interesting construction of a treat dispenser fastened on the animal will be examined hereinafter. Instead of the activation of the treat dispenser via a remote controller by means of radio, activation by means of a light transmitter, for example a laser beam of a laser emitter La, would also be possible. If a sensor S which registers the light beam is then also located on the animal, then said sensor can forward the reception to the treat dispenser by means of an electric line, whereupon said treat dispenser ejects a treat (FIG. 70). Obviously, care would in that case have to be taken to ensure that the light cannot damage the animal's eyes.

A further sensor located on the animal could be a sound recognition module MdT which is integrated into the treat dispenser L or connected thereto via radio or cables and ensures that a treat is released after specific words are spoken. Thus, a person who is present can for example cause a treat to be given, without having to hold a remote controller in his hand, by calling certain words or for example clapping his hands or using a specific dog whistle, and the voice or noise recognition tool recognizes these sounds (FIG. 71). The sounds can however also be transmitted by a remote controller.

For the sake of completeness, it should also be noted that the triggering of the release of a treat by means of radio includes all known command transmission systems. Thus, the owner can also easily administer directly from thousands of kilometers away a treat to a dog being observed via a webcam if the transmitter and receiver are set up in accordance with each other.

It should also be noted that all treat dispensers which have been mentioned here and are located on the animal can also be used for treat dispensers located in the environment.

Summarizing statements and possible configurations of this variant of an animal training device (embodiments of a treat dispenser):
That the treat dispenser has one or more chambers or chambers each having its own closure, wherein, in each case after an individual radio signal which is suitable for each chamber, the closure of a chamber is opened and thus the entire content of this chamber is completely emptied.
That instead of the chambers, other elements are arranged for holding food.
That these elements for holding the food are clamps.
That there is provided a sensor which recognizes light beams and as a result causes a treat to be released.
That there is provided a sound recognition module which triggers a treat to be released on reception of a specific sound.
That an additional voice recorder is integrated, so that on activation of the treat dispenser, in addition to the delivery of the treat, another rewarding is also carried out in the form of the acoustic playing-back of a praise from the owner.
That there is provided an additional dispensing mechanism for releasing a toy, so that on activation of the treat dispenser, in addition to the delivery of the treat, a small toy is also delivered.
That a graded delivery of amounts of treats is possible in that a plurality of portions are administered at once, or in that different-sized food chambers open.
That, in addition to the delivery of the treat, acoustic praise stored on a recorder can also be released, or that a toy can additionally be delivered.
That an activation of a treat dispenser to deliver a treat at a distance is possible even without a remote controller in that an integrated noise recognition system responds to specific sounds, words, etc.
That an activation of a treat dispenser to deliver a treat at a distance is possible even without a remote controller in that an integrated light recognition system responds to specific light signs, for example laser light.

P. A further variant of an animal training device will be described hereinafter: This is a further particular embodiment of a treat dispenser, specifically of the remote controller of a treat dispenser fastened on the animal.

For the training of dogs, use may very well be made of a treat dispenser L which is fastened on the collar H and can deliver treats Le in a portioned manner after a remote control signal (FIG. 72). The remote controller F is operated by the human and helps to ensure that the treat can be administered to the dog always precisely at the moment when it does something right. Normally, the dog registers when a treat falls out, simply by virtue of the mechanical dispensing noise. That is to say, the remote controller has a button, on actuation of which merely a treat falls out. A second button in the remote controller could also eject a treat via remote control but at the same time activate a sound transmitter in the remote controller, so that an additional sound is generated. A third button could have the function of merely generating a sound but not transmitting a radio signal to the treat dispenser, so that no treat is ejected. This sound generated in this case would however differ clearly from the sound generated on actuation of the second button. Thus, the sound generated by the third button could serve to carry out what is known as clicker training. The sounds generated in the remote controller have the advantage that the dog associates the giving of the treat more with the human, as the sound comes from the direction of the human. Obviously, it would also be possible for the sound transmitter or transmitters to be located not in the remote controller, but rather in the treat dispenser. This would have the advantage that the dog hears the sounds equally well at all times. The buttons 1, 2 and 3 in the remote controller would then again decide whether a sound is generated and, if so, which, and whether a treat is ejected; however, the sound transmitter or transmitters would then be located in the treat dispenser.

It would of course also be conceivable for there to be located at the same time two sound transmitters in the remote controller and two sound transmitters in the treat dispenser, and for a new decision to be made each time by means of 5 buttons of the remote controller, depending on the training situation, as to where the sound is generated, whether a sound is generated at all, whether or not a treat is to fall out, whether the treat is to fall out with or without an additional sound, and where this sound is generated. In addition to the sound, other additional signals, such as example light signs, additional vibration of the treat dispenser, etc., would also be conceivable. It would also be conceivable for additional signal transmitters to be activated in the remote controller and at the same time in the dispenser on actuation of the remote controller. That is to say, the dog keeper would have manifold opportunities to act via remote controller in accordance with the demands of the training situation. The remote controller would, as a result of the arrangement and the correspondingly required number of actuating buttons, open up all possibilities.

Summarizing statements and possible configurations of this variant of an animal training device (construction of the remote controller):
That the remote control treat dispenser can have additional signal transmitters for indicating the ejection of the treat in the remote controller or in the treat dispenser.
That triggering means for all constellations desired in the training are located in the remote controller.

Basic assertions for all variants proposed in the present document of a device for the preferably automatic training of animals, especially while using a treat dispenser fastened on the animal:
That the device has timing circuits, time measuring apparatuses, timers or random generators which define time intervals, moments or durations in which the sensors and measuring means of the device measure the correct or undesirable behavior of the animal, whereupon a treat dispenser, which also forms part of the device, then delivers a treat as a reward, and that a sequence is thus possible without the human being present.
That the treat dispenser is a treat dispenser which is fastened on the animal, is activated by means of a receiver via radio and as a result allows new training possibilities, or else the transmitter is located in the environment.
That it has a treat dispenser which is fastened on the animal and is activated via radio, and thus the animal training device requires only one treat dispenser.
That the treat dispenser fastened on the animal also has elements for fastening in the environment.
That the device preferably has an electromechanical construction which can be powered by a battery, rechargeable battery or connection to the electric power supply.
That the device has timers, timing circuits or random generators which intermittently switch the device on completely or intermittently switch it off completely.
That the device has additional timing circuits or timers which define a time interval or a moment at which one or more measuring instruments are activated.
That the device has additional timing circuits or timers which define a time interval or a moment at which one or more measuring instruments are activated.
That it has a timing circuit which carries out a measurement again and again for a short time at a regular interval.
That it has a timing circuit which defines a time, that the dog is always given a treat when it does not display an undesirable behavior for a certain time.
That it has a timing circuit which after a misbehavior defines a time interval, in that non-displaying of the misbehavior (ascertained by a sensor or a measuring means which is present in the device) triggers the dispensing of a treat by the treat dispenser.
That it has timing circuits or timers which measure the speed with which a task is completed.
That it has timing circuits or timers which define a time interval within which the animal can still successfully perform the task.
That there are signal transmitters (for example sound transmitters, lamps, mechanical indicators) which, provided that they are active, indicate to the animal that it is for example still worth doing what is asked of it, or that it is in a monitoring interval.
That there are additional time measuring apparatuses for measuring a time interval and/or motion detectors, exceeding and activation of which cause the disappearance of a treat which has already been administered.
That the treat dispenser contains a receiver for acoustic signals causing a treat to be released on activation.
That a receiver for optical signals, which causes a treat to be released on activation, is located in the treat dispenser.
That time detection systems are coupled to means for measuring the behavior of an animal, and that this defines whether or not a treat dispenser delivers a treat.
That a graded delivery of amounts of treats is possible in that a plurality of portions are administered at once, or in that different-sized food chambers open.
That, in addition to the delivery of the treat, an acoustic praise stored on a recorder can also be released, or that a toy can additionally be delivered.
That an activation of a treat dispenser for delivering treats is possible at a distance even without a remote control in that an integrated noise recognition system responds to specific sounds, words, etc.
That an activation of a treat dispenser for delivering treats is possible at a distance even without a remote controller in that an integrated light recognition system responds to specific light signs, for example laser light.
That all variants, embodiments and special features proposed in the present document of a device can be combined with one another in any desired manner. Thus, use may for example be made of all constructions listed in the present document of a treat dispenser, be it carried on the animal or secured in the environment, during the human's training with the dog; they can however also be used in the case of all disclosed animal training arrangements which can proceed automatically without the dog keeper being present.
That special features of a construction that has been cited only in the case of this construction are of course also possible in the case of all other constructions listed or are transferable thereto.
That various constructions can be combined with one another in a broad range of ways. Thus, for example, a training system for sheepdogs can be activated at the same time as an anti-barking means, etc.
That graded rewarding is possible, a small/large food portion, optionally combined with praise by way of a voice recorder or delivery of a toy, etc.
That timing circuits detect when an undesirable behavior is not displayed for a certain time, and a treat is then awarded.
That timing circuits detect when a desired behavior is displayed for a certain time, and a treat is then awarded.
That timing circuits begin measuring from the moment when a specific behavior was displayed and a time interval is then automatically defined in which not continuing to display the behavior or else continuing to display the behavior is rewarded.

In principle, all of the described arrangements are conceivable for all animal species. In this way, attempts are made to allow the natural behavior of the animals in nature and thus to satisfy the applied requirements of the individual animal species. The electric power is supplied via batteries, rechargeable batteries or a socket, transformer. Food dispensers, and also any other elements such as motion detectors, light barriers, etc., have fastening possibilities, so that the overall entity can be mounted securely, for example, on the wall. All described variants of an animal training device can of course also be applied in combination with one another.

1.-10. (canceled)

11. An animal training device as a stand-alone retrieval device for animals, characterized by at least one ejecting/issuing device for ejecting/delivering at least one article, at least one take-back device for taking back the at least one article and at least one reward dispenser for delivering a reward, in particular a treat, on taking-back of the at least one article.

12. The stand-alone retrieval device as claimed in claim 11, characterized in that the ejecting device has elements for casting out or giving out the at least one article, in particular at least one ball.

13. The stand-alone retrieval device as claimed in claim 11, characterized in that an operating sequence of the retrieval device, in particular of the ejecting/issuing device, is time-adjustable and/or is controllable by means of a random generator.

14. The stand-alone retrieval device as claimed in claim 11, characterized in that the take-back device has mechanical and/or electronic detection elements for recognizing/detecting the at least one article.

15. The stand-alone retrieval device as claimed in claim 11, characterized in that it is embodied in such a way that a reward is given out by means of the reward dispenser on detection of the at least one article in the take-back device by means of the detection elements.

16. The stand-alone retrieval device as claimed in claim 11, characterized in that the ejecting device, the take-back device and the reward dispenser are embodied as a unit or so as to be at least partly spatially separated from one another.

17. The stand-alone retrieval device as claimed in claim 11, characterized in that the ejecting device, the take-back device and the reward dispenser are embodied so as to operate in adaptation to one another or to operate at least partly independently of one another.

18. The stand-alone retrieval device as claimed in claim 11, characterized in that the take-back device and the reward dispenser are embodied as a mechanical unit.

19. The stand-alone retrieval device as claimed in claim 11, characterized by at least one motivation element, in particular an acoustic and/or visual motivation element, for motivating the animal and/or for indicating that the animal is given a reward on bringing back the article in good time.

20. The stand-alone retrieval device as claimed in claim 11, characterized by at least one timer or timing circuit, for defining a period of time in which the at least one article must reach the take-back device for a reward to be given out.

21. The stand-alone retrieval device for animals as claimed in claim 11, characterized in that the issuing means has an opening and a closure, so that after opening of the closure all articles, induced merely by gravity, leave the issuing means, and said issuing means is thus also able simultaneously to deliver a large number of articles.

22. A method for encouraging an animal, in particular a dog, to retrieve, characterized in that a treat dispenser renders a food ration accessible when an article or articles, cast out or given out beforehand by an ejecting device, is or are brought (in good time) to a take-back device.

23.-41. (canceled)

42. Embodiments of a treat dispenser fastened on an animal's collar, characterized in that there is provided a module for sound recognition which triggers the release of a treat on receiving a specific sound.

43-46. (canceled)
